(19) United States
(12) Patent Application Publication
(10) Pub. No.: US 2017/0226857 A1
(43) Pub. Date: Aug. 10, 2017

(54) ENERGY RECOVERY DEVICE WITH HEAT DISSIPATION MECHANISMS

(71) Applicant: EATON CORPORATION, Cleveland, OH (US)

(72) Inventors: Veerangowda S. PATIL, Borhadewadi, Pune (IN); Sheetalkumar Shamrao PATIL, Wadgaon Sheri, Pune (IN); William Nicholas EYBERGEN, Harrison Township, MI (US); Matthew James FORTINI, Livonia, MI (US)

(21) Appl. No.: 15/502,670

(22) PCT Filed: Jul. 30, 2015
(86) PCT No.: PCT/US2015/042922

§ 371 Date: Feb. 8, 2017

(30) Foreign Application Priority Data
Aug. 8, 2014 (IN) 2260/DEL/2014

(51) Int. Cl. F01C 11/00; F01C 21/10; F01C 17/02; F02B 67/08; F01C 1/16

(52) U.S. Cl. CPC F01C 11/006; F02B 67/08; F01C 1/16; F01C 17/02; F01C 21/10

(57) ABSTRACT

The present teachings generally include an energy recovery device with heat dissipation mechanisms. The energy recovery device can include a main housing, rotors disposed in the main housing, rotor shafts associated with the rotors, and a sub-housing. The sub-housing can have an engaging surface that faces and is spaced apart from the first receiving surface of the main housing with a first gap when the first sub-housing is attached to the main housing.

### CROSS-REFERENCE TO RELATED APPLICATION(S)

This application is being filed on Jul. 30, 2015, as a PCT International Patent application and claims priority to Indian Provisional Patent Application Serial No. 2260/DEL/2014 filed on Aug. 8, 2014, the disclosure of which is incorporated herein by reference in its entirety.

### TECHNICAL FIELD

The present teachings relate to an energy recovery device with heat dissipation mechanisms.

### BACKGROUND

Waste heat energy is necessarily produced in many processes that generate energy or convert energy into useful work, such as a power plant. Typically, such waste heat energy is released into the ambient environment. In one application, waste heat energy is generated from an internal combustion engine in the form of exhaust gases that can have a high temperature and pressure. Some energy recovery approaches have been developed to recover waste energy via a working fluid and re-use the recovered energy in the same process or in separate processes. In one example, the working fluid is exhaust from an internal combustion engine or a fuel cell. When in operation, the components of the energy recovery systems can be subjected to high temperature of the work fluid. For example, several operative components of the energy recovery system (e.g., rotating shafts, gears and bearings) can be subjected to heat transferred from the exhaust gases at a high temperature. In some cases, the heat from the working fluid can damage these components.

### SUMMARY

In general terms, the present teachings generally include an energy recovery device with heat dissipation mechanisms. Various aspects are described herein, which include, but are not limited to, the following aspects.

One aspect is an energy recovery device including a main housing, a plurality of rotors, a plurality of rotor shafts, a first sub-housing, and a plurality of rotatory components. The main housing has inlet and outlet ports and a first receiving surface. The inlet port is configured to admit a working fluid, and the outlet port is configured to discharge the working fluid. The plurality of rotors is rotatably disposed in the main housing. The plurality of rotor shafts is associated with the plurality of rotors, respectively. The first sub-housing has an engaging surface and is attached to the main housing. The plurality of rotatory components is rotatably disposed in the first sub-housing and operatively coupled to the plurality of rotor shafts, respectively. At least part of the engaging surface of the first sub-housing faces, and is spaced apart from, the first receiving surface of the main housing with a first gap therebetween when the first sub-housing is attached to the main housing.

The first sub-housing may include at least one first projection extending from the engaging surface of the first sub-housing. The at least one first projection can have a first height equal to the first gap when the first sub-housing is attached to the main housing.

Another aspect is an energy recovery device including a main housing, a plurality of rotors, a plurality of rotor shafts, and a first sub-housing. The main housing has inlet and outlet ports and a first receiving surface. The inlet port is configured to admit a working fluid, and the outlet port is configured to discharge the working fluid. The plurality of rotors is rotatably disposed in the main housing. The plurality of rotor shafts is associated with the plurality of rotors, respectively. The first sub-housing has an engaging surface. The engaging surface of the first sub-housing is engaged with the first receiving surface of the main housing. A thermal insulation coating is provided on one of at least a portion of the first receiving surface of the main housing and at least a portion of the engaging surface of the first sub-housing.

Yet another aspect is an energy recovery device including a main housing, a plurality of rotors, a plurality of rotor shafts, and a first sub-housing. The main housing has inlet and outlet ports and a first receiving surface. The inlet port is configured to admit a working fluid, and the outlet port is configured to discharge the working fluid. The plurality of rotors is rotatably disposed in the main housing. The plurality of rotor shafts is associated with the plurality of rotors, respectively. The first sub-housing has an engaging surface. The engaging surface of the first sub-housing is engaged with the first receiving surface of the main housing. The first sub-housing may further include a plurality of first bearings, a first oil path, a first oil inlet, and a first oil outlet. The first bearings are configured to support the plurality of rotor shafts in the first sub-housing. The first oil path is provided around the plurality of first bearings. The first oil inlet is arranged on the first sub-housing and configured to receive a lubricant. The first oil inlet is in fluid communication with the first oil path. The first oil outlet is arranged on the first sub-housing and configured to discharge the lubricant. The first oil outlet is in fluid communication with the first oil path. The first oil path is arranged between the plurality of rotatory components and the engaging surface of the first sub-housing. The first oil outlet is arranged farther from the engaging surface of the first sub-housing than the first oil path.

Yet another aspect is an energy recovery device including a main housing, a plurality of rotors, a plurality of rotor shafts, a first sub-housing, a second sub-housing, an oil outlet, and an oil inlet. The main housing may have inlet and outlet ports. The inlet port may be configured to admit a working fluid, and the outlet port may be configured to discharge the working fluid. The plurality of rotors may be rotatably disposed in the main housing. The plurality of rotor shafts may be associated with the plurality of rotors. Each of the plurality of rotor shafts may have a first end and a second end along an axis of rotation. At least one of the plurality of rotor shafts may include a hollow at least partially extending between the first and second ends along the axis of rotation. The first sub-housing may be attached to the main housing and include a first interior configured to at least partially receive the plurality of rotor shafts and rotatably support the plurality of rotor shafts at the first end. The second sub-housing may be attached to the main housing and include a second interior configured to at least partially receive the plurality of rotor shafts and rotatably support the plurality of rotor shafts at the second end. The oil outlet may be in fluid communication with the first interior of the first sub-housing and configured to discharge the oil therefrom. The oil inlet may be in fluid communication with the second interior of the second sub-housing and configured to receive the oil therein. The hollow may be configured to be in fluid communication with the first interior of the first sub-housing at the first end and in fluid communication with the second interior of the second sub-housing at the second end to enable an oil to flow between the first and second interiors. In some examples, the device may further include at least one plain bearing configured to rotatably support at least one of the rotor shafts at the second end thereof within the second sub-housing.

Yet another aspect is an energy recovery device including a housing, a plurality of rotors, and a plurality of rotor shafts. The housing may include an oil inlet and an oil outlet and have inlet and outlet ports. The inlet port may be configured to admit a working fluid, and the outlet port may be configured to discharge the working fluid. The plurality of rotors may be rotatably disposed in the housing. The plurality of rotor shafts may be associated with the plurality of rotors. Each of the plurality of rotor shafts may have a first end and a second end along an axis of rotation, and at least one of the plurality of rotor shafts may include a hollow at least partially extending between the first and second ends along the axis of rotation to enable an oil to flow therethrough between the first and second ends. The oil inlet may be configured to receive the oil and in fluid communication with the hollow of the rotor shaft at the first end to enable the oil to flow from the oil inlet to the hollow of the rotor shaft at the first end. The oil outlet may be configured to discharge the oil therefrom and in fluid communication with the hollow of the rotor shaft at the second end to discharge the oil from the hollow of the rotor shaft to the oil outlet at the second end.

### BRIEF DESCRIPTION OF THE DRAWINGS

Non-limiting and non-exhaustive examples are described with reference to the following figures, which are not necessarily drawn to scale, wherein like reference numerals refer to like parts throughout the various views unless otherwise specified.

FIG. 1 is a perspective view of an example energy recovery device with several heat dissipation mechanisms according to the principles of the present teachings.

FIG. 2 is a cross-sectional view of the energy recovery device of FIG. 1.

FIG. 3 is an expanded perspective view of a first sub-housing of the energy recovery device of FIG. 1.

FIG. 4 is an expanded perspective view of the first sub-housing of FIG. 3.

FIG. 5 is an expanded perspective view of a second sub-housing of the energy recovery device of FIG. 1.

FIG. 6 is an expanded perspective view of the second sub-housing of FIG. 5.

FIG. 7 is an enlarged cross-sectional side view of an engagement region between a main housing and the first sub-housing, as indicated in FIG. 2.

FIG. 8 is an expanded perspective view of an example engaging surface of the first sub-housing of FIG. 7.

FIG. 9 is an enlarged cross-sectional side view of an engagement region between the main housing and a second sub-housing, as indicated in FIG. 2.

FIG. 10 is an expanded perspective view of an example engaging surface of the second sub-housing of FIG. 9.

FIG. 11 is a cross-sectional end view of the first sub-housing, illustrating a first oil cooling mechanism of the first sub-housing as yet another example of the heat dissipation mechanism according to the principles of the present teachings.

FIG. 12 is a cross-sectional end view of the second sub-housing, illustrating a second oil cooling mechanism of the second sub-housing as yet another example of the heat dissipation mechanism according to the principles of the present teachings.

FIG. 13 is a perspective view of the energy recovery device of FIG. 1 with finned elements on the first and second sub-housings, illustrating another example of the heat dissipation mechanism according to the principles of the present teachings.

FIG. 14 is a perspective view of an example energy recovery device with several heat dissipation mechanisms according to the principles of the present teachings.

FIG. 15 is another perspective view of the energy recovery device of FIG. 14.

FIG. 16 is a cross-sectional view of the energy recovery device of FIG. 14.

FIG. 17 is an expanded view of a first sub-housing.

FIG. 18 is an expanded view of the first sub-housing of FIG. 17.

FIG. 19 is an expanded view of a second sub-housing.

FIG. 20 is an expanded view of the second sub-housing of FIG. 19.

FIG. 21 is a cross-sectional view of the second sub-housing of FIG. 19.

FIG. 22 is a perspective view of an example second bearing.

FIG. 23 is a perspective view of the second bearing of FIG. 22.

FIG. 24 is a cross-sectional view of another example energy recovery device according to the principles of the present teachings.

FIG. 25 is a cross-sectional view of yet another example energy recovery device according to the principles of the present teachings.

FIG. 26 is a schematic view of a vehicle in which an energy recovery device of the type shown in FIGS. 1-25 may be used.

### DETAILED DESCRIPTION

Various examples will be described in detail with reference to the drawings, wherein like reference numerals represent like parts and assemblies throughout the several views. Reference to various examples does not limit the scope of the claims attached hereto. Additionally, any examples set forth in this specification are not intended to be limiting and merely set forth some of the many possible examples for the appended claims.

### Heat Dissipation Mechanisms

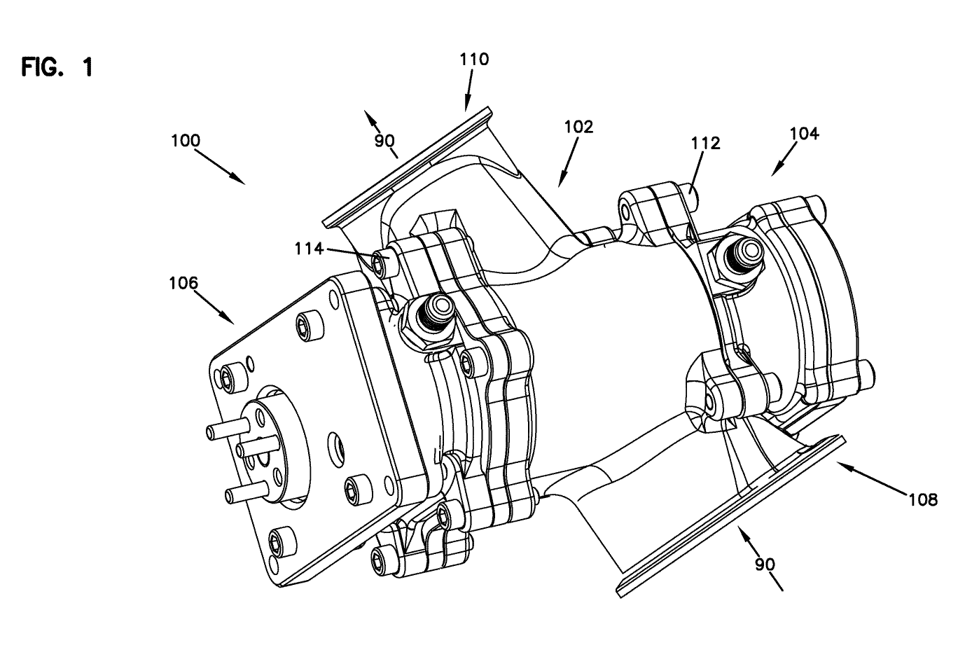

FIG. 1 is a perspective view of an example energy recovery device 100 with several heat dissipation mechanisms according to the principles of the present teachings.

The heat dissipation mechanisms can be configured to insulate several operating components of the energy recovery device 100 from heat transferred from a working fluid 90 of the expander 100. As described, the working fluid 90 can be all or part of an exhaust gas stream from an internal combustion engine or a fuel cell. In one aspect, the working fluid 90 can be at a relatively high temperature. For example, the working fluid 90 can have a temperature of about 950° C. As described, the rotor shafts 118 of the device 100 are exposed to the high temperature working fluid 90 and transfer heat to other operative elements proximate the rotor shaft and/or associated therewith, such as shaft bearings. As discussed later, significant heat transfer can also occur through the housing 102 of the energy recovery device 100. Thus, it is important to effectively dissipate the heat from the areas proximate the operating elements of the device 100 to prevent damages on the operating elements.

Referring to FIG. 1, the energy recovery device 100 can include a main housing 102, a first sub-housing 104, and a second sub-housing 106.

The main housing 102 can include an inlet port 108 and an outlet port 110. The inlet port 108 can be configured to admit the working fluid 90 at a first pressure P1 and a first temperature T1. In some examples, the working fluid 90 can be an exhaust gas stream from an internal combustion engine. The outlet port 110 can be configured to discharge the working fluid 90 at a second pressure P2 and a second temperature T2. In one application, the second pressure P2 is lower than the first pressure P1, and the second temperature T2 is lower than the first temperature T1, where the energy recovery device 100 operates to expand the working fluid 90 as the working fluid 90 passes through the device 100. As the working fluid 90 undergoes the expansion through the device 100, the device 100 operates to generate a mechanical work through an output shaft.

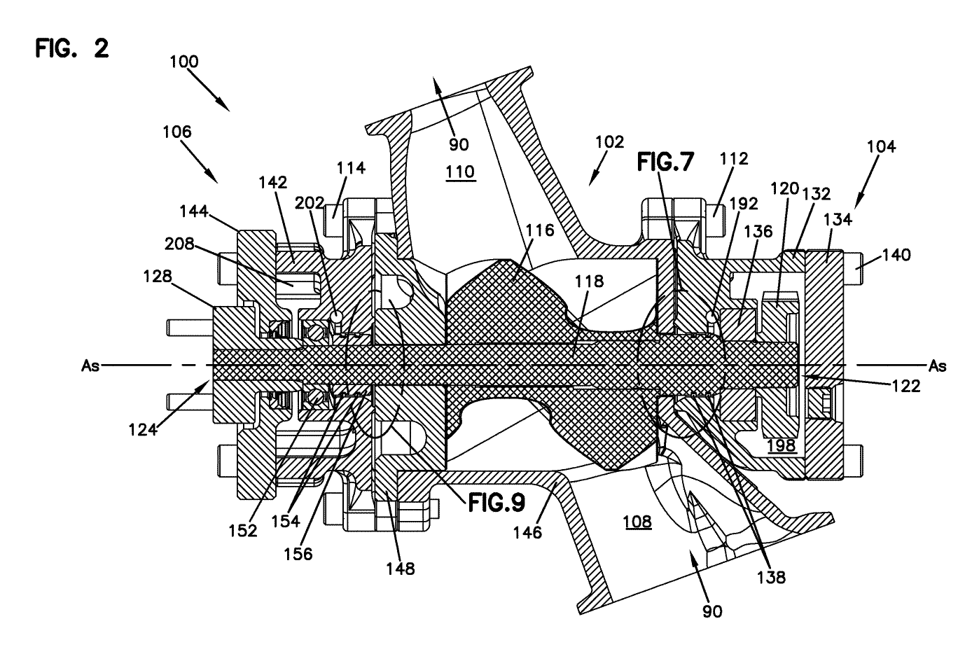

The first sub-housing 104 can be attached to the main housing 102 and configured to receive first ends 122 of a plurality of rotor shafts 118 and a plurality of meshed timing gears 120 (FIG. 2). As described below, the meshed timing gears 120 can be rotatably disposed within the first sub-housing 104. In some examples, the first sub-housing 104 can be coupled to the main housing 102 with fasteners 112, such as machine screws or bolts. An example configuration associated with the first sub-housing 104 is described and illustrated with reference to FIGS. 2-4.

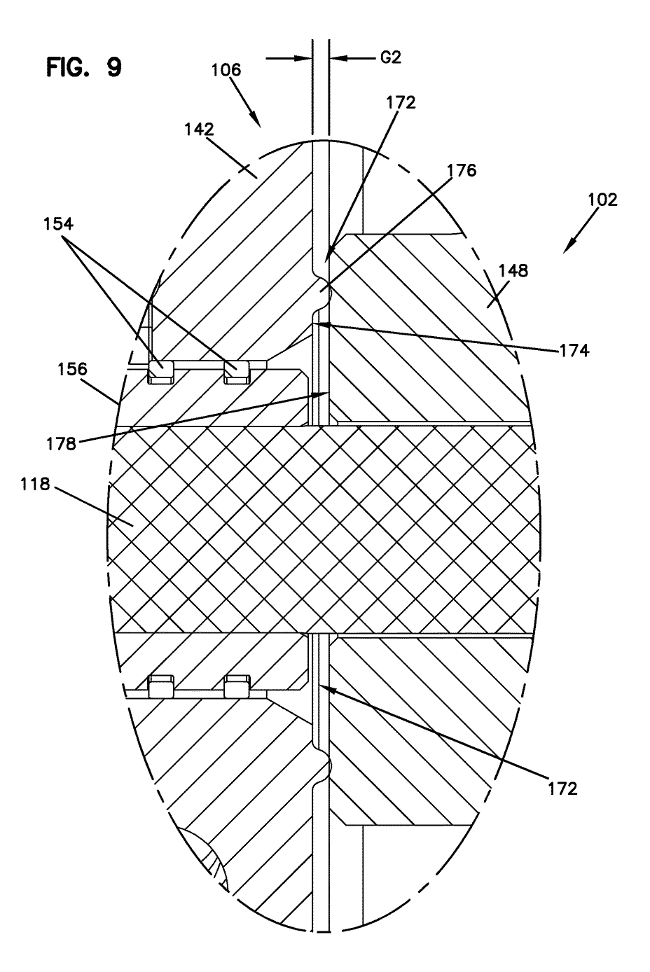

The second sub-housing 106 can be attached to the main housing 102 and configured to receive second ends 124 of the plurality of rotor shafts 118 (FIG. 9). As described below, the second ends 124 of the plurality of rotor shafts 118 can be rototably disposed within the second sub-housing 106. In some examples, the second sub-housing 106 can be coupled to the main housing 102 with fasteners 114, such as machine screws or bolts. An example configuration associated with the second sub-housing 106 is described and illustrated with reference to FIGS. 2, 5 and 6.

FIG. 2 is a cross-sectional view of the energy recovery device 100 of FIG. 1. The energy recovery device 100 can include a plurality of rotors 116, a plurality of rotor shafts 118, and a plurality of rotary components 120.

The plurality of rotors 116 can be rotatably disposed in the main housing 102 and configured to expand the working fluid 90 from the first pressure and temperature P1 and T1 to the second pressure and temperature P2 and T2 as the working fluid 90 passes through the plurality of rotors 116 from the inlet port 108 to the outlet port 110. In the depicted example, the energy recovery device 100 includes two rotors 116. An example of the rotors 116 is disclosed in Patent Cooperation Treaty (PCT) International Application Number PCT/US2013/078037 entitled EXHAUST GAS ENERGY RECOVERY SYSTEM. PCT/US2013/078037 is herein incorporated by reference in its entirety.

The plurality of rotor shafts 118 can be associated with the plurality of rotors 116. In some examples, each of the plurality of rotor shafts 118 can be fixed to each rotor 116. In other examples, each rotor shaft 118 can be integrally formed with each rotor 116. The plurality of rotor shafts 118 can have first and second ends 122 and 124 and can extend along an axis of rotation A_{S}. As described below, the rotor shafts 118 can extend from the main housing 102 and can be rotatably supported by the first sub-housing 104 at the first ends 122. Further, the rotor shafts 118 can extend from the main housing 102 and can be rotatably supported by the second sub-housing 106 at the second ends 124.

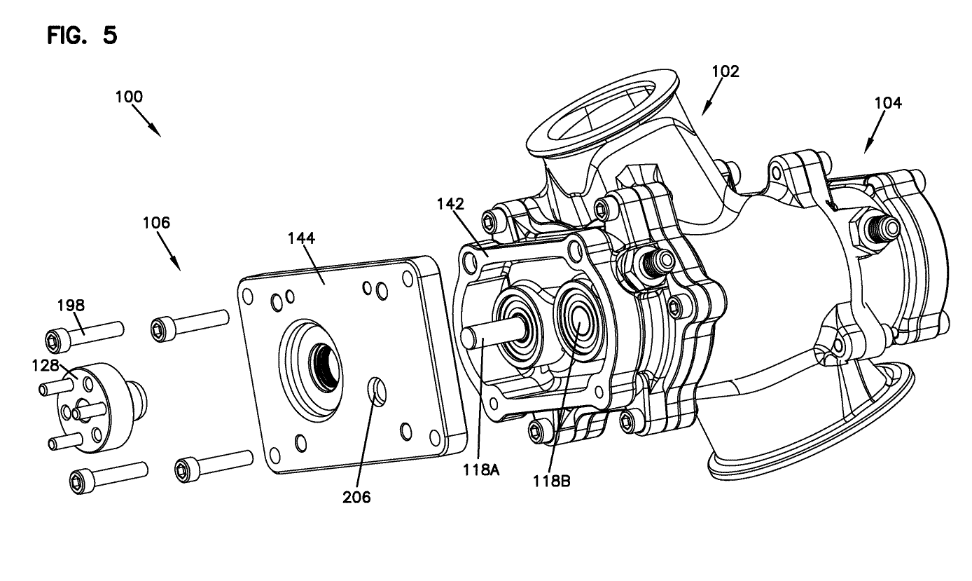

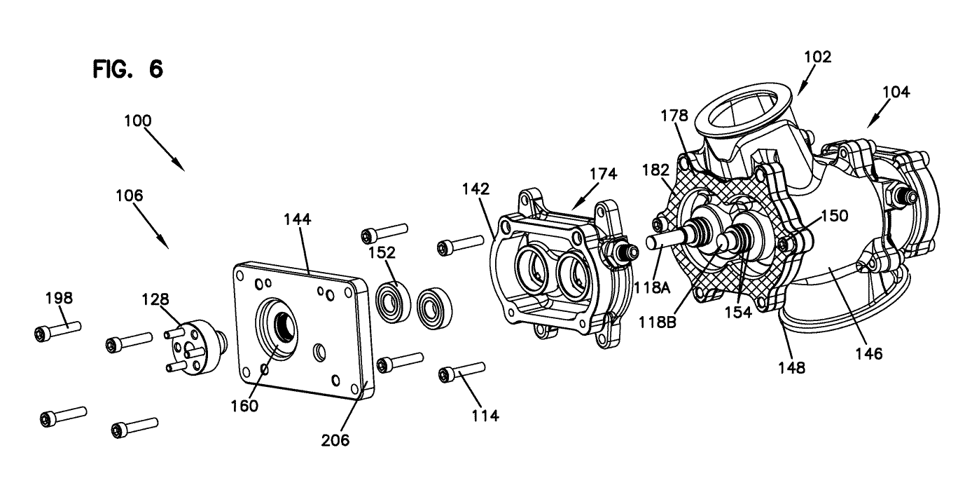

In the depicted example, the energy recovery device 100 can have two rotor shafts 118A and 118B (collectively, 118) that can be fixed to each of the two rotors 116. One of the rotors shafts 118 can be an output shaft 118A (FIGS. 5 and 6) through which a mechanical work is generated. The second end 124 of the output shaft 118A can engage a driving head 128 rotatably supported by the second sub-housing 106. The driving head 128 can be configured to engage a power transmission mechanism (not shown) for delivering the mechanical work from the rotating output shaft 118A.

The plurality of rotary components 120 can be rotatably disposed in the first sub-housing 104 and coupled to the plurality of rotor shafts 118, respectively. In some examples, the rotary components 120 include timing gears that can be meshed with each other in the first sub-housing 104.

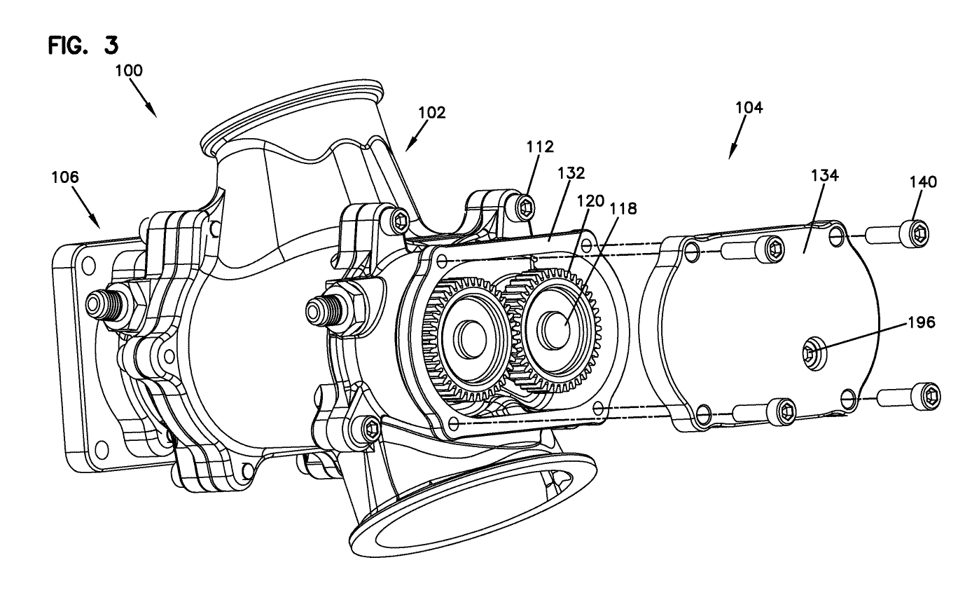

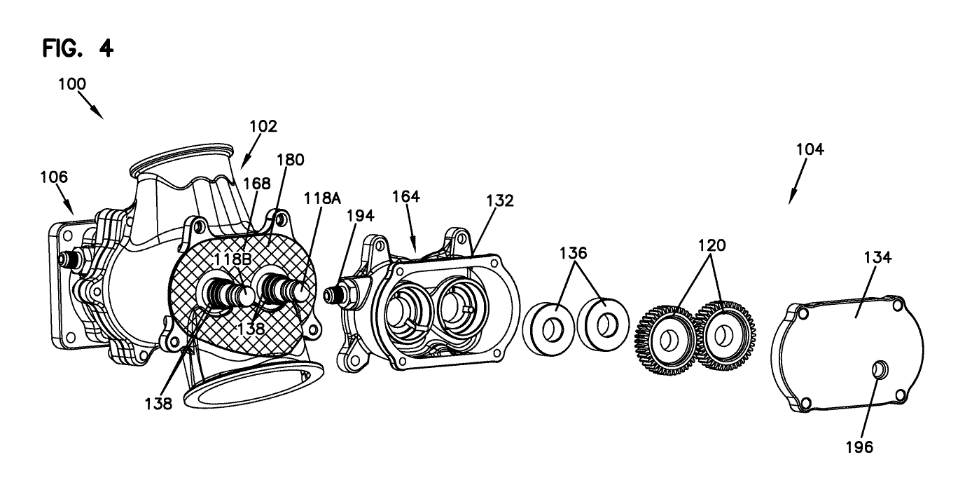

FIGS. 3 and 4 are expanded views of the first sub-housing 104. Referring to FIGS. 2-4, in some examples, the first sub-housing 104 can include a first sub-body 132 and a first sub-cap 134.

The first sub-body 132 can be configured to rotatably support a portion of the rotor shafts 118 at the first ends 122 when attached to the main housing 102. In some examples, the first sub-body 132 can include a plurality of first bearings 136 configured to be mounted into the first sub-body 132 and configured to rotatably support the rotor shafts 118, respectively. As depicted, the timing gears 120 can be engaged with the first ends 122 of the rotor shafts 118 while being meshed with each other.

In some examples, the rotor shafts 118 can include first sealing elements 138 engaged therearound at or adjacent the first ends 122. The first sealing elements 138 can be arranged between the main housing 102 and the first bearings 136 and configured to provide sealing around the rotors shafts 118 that are rotatably disposed in the first sub-housing 104. Examples of the first sealing elements 138 include O-rings and turbo seal rings. In the depicted example, each rotor shaft 118 can include two first sealing elements 138 therearound.

The first sub-cap 134 can be configured to cover the first sub-body 132 when the first bearings 136, the meshed timing gears 120, and other associated components are disposed in the first sub-body 132. In some examples, the first sub-cap 134 can be sealingly coupled to the first sub-body 132 with fasteners 140, such as machine screws or bolts.

As such, the first sub-housing 104 can be configured to arrange the first bearings 136 and the timing gears 120 at a location outside the main housing 102 to reduce heat transfer from the main housing 102 to the first bearings 136, the timing gears 120 and other operative components. In some examples, the first sub-housing 104 can be made from one or more materials with high thermal conductivity, which increase heat dissipation. One example of the materials is aluminum.

FIGS. 5 and 6 are expanded views of the second sub-housing 106. Referring to FIGS. 2, 5 and 6, in some examples, the second sub-housing 106 can include a second sub-body 142 and a second sub-cap 144.

The second sub-body 142 can be configured to rotatably support a portion of the rotor shafts 118 at the second ends 124 when attached to the main housing 102. In one example, the main housing 102 can include a main body 146 and a main housing cover 148 configured to be sealingly coupled to the main body 146 (with fasteners 150, for example) to define a chamber 149 of the main housing 102. In this configuration, the second sub-body 142 can be attached to the main housing cover 148. For example, the second sub-body 142 is coupled to the main housing cover 148 with the fasteners 114.

In some examples, the second sub-body 142 can include a plurality of second bearings 152 configured to be mounted into the second sub-body 142 and configured to rotatably support the rotor shafts 118, respectively.

In some examples, the rotor shafts 118 can include second sealing elements 154 engaged therearound at or adjacent the second ends 124. The second sealing elements 154 can be arranged between the main housing 102 and the second bearings 152 and configured to provide sealing around the rotor shafts 118 that are rotatably disposed in the second sub-housing 106. Examples of the second sealing elements 154 include O-rings and turbo seal rings. In the depicted example, each rotor shaft 118 includes two second sealing elements 154 therearound.

The second sub-cap 144 can be configured to cover the second sub-body 142 when the second bearings 152 and other associated components are disposed in the second sub-body 142. In some examples, the second sub-cap 144 can be sealingly coupled to the second sub-body 142 with fasteners 158, such as machine screws or bolts.

The second sub-cap 144 can be configured to rotatably support the driving head 128 coupled to the output rotor shaft 118A. In some examples, the second sub-cap 144 can include a driving head recess 160 onto which the driving head 128 sits and rotates relative to the second sub-cap 144.

As such, the second sub-housing 106 is configured to arrange the second bearings 152 and other operative components at a location outside of the main housing 102 to reduce heat transfer from the main housing 102 to the second bearings 152 and other components. In some examples, the second sub-housing 106 can be made from one or more materials with high thermal conductivity, which increase heat dissipation. One example of the materials is aluminum.

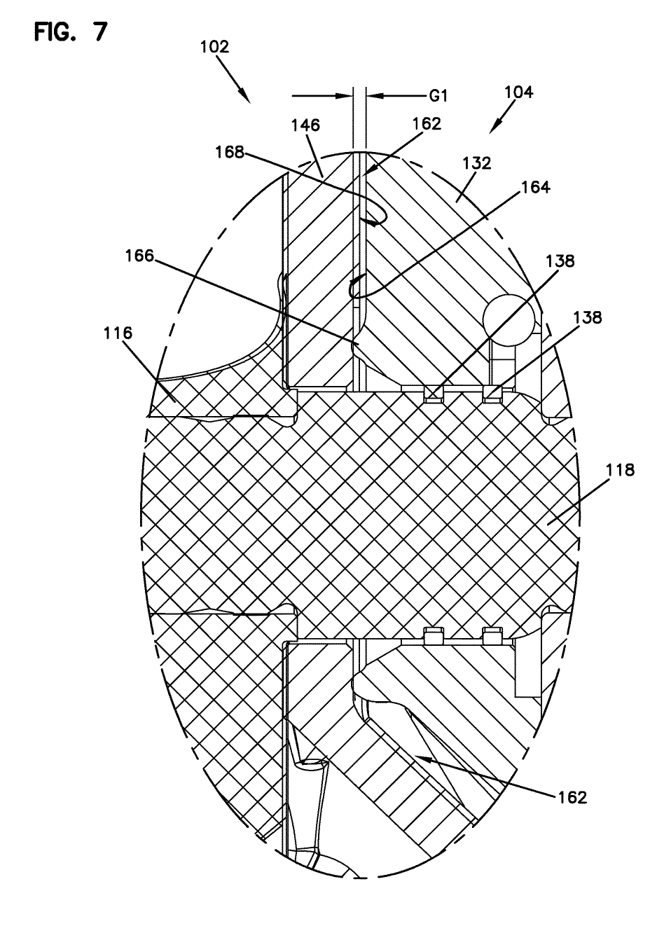

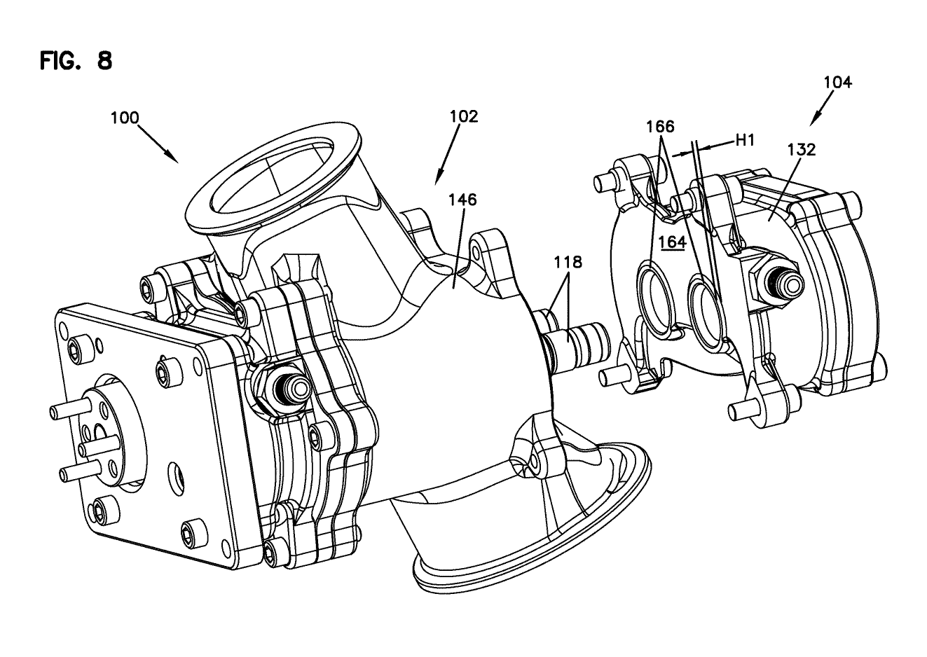

FIGS. 7 and 8 illustrate an example heat dissipation mechanism according to the principles of the present teachings. In particular, FIG. 7 is an enlarged view of an engagement region between the main housing 102 and the first sub-housing 104, as shown in FIG. 2. FIG. 8 is a perspective view of an example engaging surface of the first sub-housing 104 of FIG. 7.

As depicted, when the first sub-housing 104 is attached to the main housing 102 and supports the rotor shafts 118 at the first ends 122, at least part of the first sub-housing 104 can face and be spaced apart from the main housing 102 to form a first gap 162 between the first sub-housing 104 and the main housing 102.

In some examples, the first sub-housing 104 can include an engaging surface 164 on the first sub-body 132 and at least one first projection 166 extending from the engaging surface 164. In the depicted example, the first sub-housing 104 can have the first projections 166 formed on the engaging surface 164 to surround the rotor shafts 118 passing through the first sub-housing 104. When the first sub-housing 104 is attached onto a first receiving surface 168 of the main housing 102, the first projections 166 can be abutted to the first receiving surface 168 of the main housing 102 and form the first gap 162 between the first receiving surface 168 of the main housing 102 and the engaging surface 164 of the first sub-housing 104. Therefore, the first projection 166 can have a first height equal to the first gap 162 (G1) when the first sub-housing 104 is attached to the main housing 102 (FIG. 7).

In some examples, the first projections 166 can be configured to elastically or plastically deformed by the main housing 102 (i.e., the first receiving surface 168 thereof) as the first sub-housing 104 is attached to the main housing 102 to engage the first projection 166 with the first receiving surface 168 of the main housing 102. For example, the first projection 166 has a first initial height (H1) (FIG. 8) greater than the first gap 162 (G1) (and, thus, the attached height of the projection 166) before the first sub-housing 104 is attached to the main housing 102. When the first sub-housing 104 is attached to the main housing 102, the first projection 166 is deformed against the first receiving surface 168 of the main housing 102, which reduces the first initial height (H1) to the first gap (G1). By being deformed, the first projection 166 can create sealing around the rotor shafts 118 between the first receiving surface 168 of the main housing 102 and the engaging surface 164 of the first sub-housing 104. In some examples, the first gap (G1) ranges between 0.1 mm and 10 mm. In other examples, the first gap (G1) is configured between 0.25 mm and 5 mm. Other ranges are also possible in different examples.

The first gap 162 between the main housing 102 and the first sub-housing 104 can operate to insulate the first sub-housing 104 from the main housing 102 through which the working fluid 90 passes, and thus reduce heat transfer from the working fluid 90 at the main housing 102 to components (e.g., the timing gears 120) within the first sub-housing 104. The first gap 162 also enables chimney effect therethrough to dissipate heat from the main housing 102 and reduce heat transfer from the main housing 102 to the first sub-housing 104. For example, the air in the first gap 162 can receive thermal energy transferred from the main housing 102 to be heated to have an increased temperature. Thus, the heated air in the first gap 162 becomes lighter than the ambient air outside the first gap 162, which has a lower temperature than the heated air in the first gap 162, creating a pressure difference between the heated air in the first gap 162 and the ambient air outside the first gap 162. Such a pressure difference can cause the heated air to flow up in the first gap 162 and draw the ambient air, which has a lower temperature than the heated air, from the lower side of the first gap 162, thereby dissipating heat from the main housing 102 and reducing heat transfer from the main housing 102 to the first sub-housing 104. The first projections 166 also function to reduce the surface area through which direct heat transfer from the main housing 102 to the first sub-housing 104 can occur.

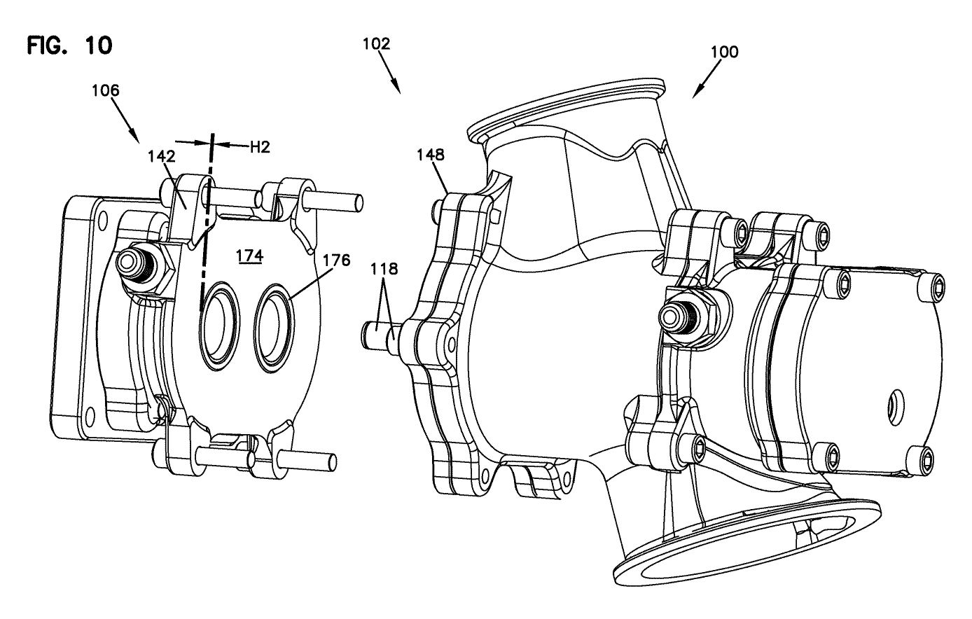

FIGS. 9 and 10 illustrate another example heat dissipation mechanism according to the principles of the present teachings. In particular, FIG. 9 is an enlarged view of an engagement region between the main housing 102 and the second sub-housing 106, as shown in FIG. 2. FIG. 10 is a perspective view of an example engaging surface of the second sub-housing 106 of FIG. 9.

As depicted, when the second sub-housing 106 can be attached to the main housing 102 and supports the rotor shafts 118 at the second ends 124, at least part of the second sub-housing 106 can face and be spaced apart from the main housing 102 to form a second gap 172 between the second sub-housing 106 and the main housing 102.

In some examples, the second sub-housing 106 can include an engaging surface 174 on the second sub-body 142 and at least one second projection 176 extending from the engaging surface 174. In the depicted example, the second sub-housing 106 can have the second projections 176 formed on the engaging surface 174 to surround the rotor shafts 118 passing through the second sub-housing 106. When the second sub-housing 106 is attached onto a second receiving surface 178 of the main housing 102 (i.e., the main housing cover 148 thereof), the second projections 176 can be abutted to the second receiving surface 178 of the main housing 102 and form the second gap 172 between the second receiving surface 178 of the main housing 102 and the engaging surface 174 of the second sub-housing 106. Therefore, the second projections 176 can have a second height equal to the second gap 172 (G2) when the second sub-housing 106 is attached to the main housing 102 (FIG. 9).

In some examples, the second projections 176 can be configured to elastically or plastically deformed by the main housing 102 (i.e., the second receiving surface 178 thereof) as the second sub-housing 106 is attached to the main housing 102 to engage the second projection 176 with the second receiving surface 178 of the main housing 102. For example, the second projection 176 can have a second initial height (H2) (FIG. 10) greater than the second gap 172 (G2) (and thus the attached height of the second projections 176) before the second sub-housing 106 is attached to the main housing 102. When the second sub-housing 106 is attached to the main housing 102, the second projections 176 can be deformed against the second receiving surface 178 of the main housing 102, which reduces the second initial height (H2) to the second gap (G2). By being deformed, the second projections 176 can create sealing around the rotor shafts 118 between the second receiving surface 178 of the main housing 102 and the engaging surface 174 of the second sub-housing 106. In some examples, the second gap (G2) ranges between 0.1 mm and 10 mm. In other examples, the second gap (G2) is configured between 0.25 mm and 5 mm. Other ranges are also possible in different examples.

Similarly to the first gap 162, the second gap 172 operates to dissipate heat from the main housing 102 and reduce heat transfer from the main housing 102 to the second sub-housing 106 by the chimney effect through the second gap 172. The second projections 176 also function to reduce the surface area through which direct heat transfer from the main housing 102 to the second sub-housing 106 can occur.

Referring again to FIG. 4, the energy recovery device 100 can include a thermal insulation coating 180 as yet another example of the heat dissipation mechanism according to the principles of the present teachings. While at least part of the first receiving surface 168 of the main housing 102 faces and is spaced apart from the engaging surface 164 of the first sub-housing 104 with the first gap 162 therebetween, the thermal insulation coating 180 can be provided on at least one of the first receiving surface 168 of the main housing 102 and the engaging surface 164 of the first sub-housing 104. In the depicted example of FIG. 4, the thermal insulation coating 180 can be formed on the first receiving surface 168 of the main housing 102. In other examples, the thermal insulation coating 180 can be formed on the engaging surface 164 of the first sub-housing 104, or on both the engaging surface 164 and the first receiving surface 168. The thermal insulation coating 180 can be applied to the entire first receiving surface 168 and/or the entire engaging surface 164. In other examples, the thermal insulation coating 180 can be applied to a portion of the first receiving surface 168 and/or a portion of the engaging surface 164.

The thermal insulation coating 180 operates to reduce heat transfer from the main housing 102 to the components (e.g., the timing gears 120) in the first sub-housing 104. Examples of the thermal insulation coating 180 include ceramic coatings or other thermal insulative paintings. Some examples that use ceramic coating as the thermal insulation coating 180 can achieve a temperature drop of 100° C. across the coating, thereby decreasing heat transfer from the main housing 102 to the first sub-housing 104.

Referring again to FIG. 6, the energy recovery device 100 can include a thermal insulation coating 182 as yet another example of the heat dissipation mechanism according to the principles of the present teachings. Similarly to the thermal insulation coating 180 as described above, the thermal insulation coating 182 can be formed on at least one of the second receiving surface 178 of the main housing 102 and the engaging surface 174 of the second sub-housing 106. In the depicted example of FIG. 6, the thermal insulation coating 182 can be formed on the second receiving surface 178 of the main housing 102. In other examples, the thermal insulation coating 182 can be formed on the engaging surface 174 of the second sub-housing 106, or on both the engaging surface 174 and the second receiving surface 178. The thermal insulation coating 180 can be applied to the entire second receiving surface 178 and/or the entire engaging surface 174. In other examples, the thermal insulation coating 180 can be applied to a portion of the second receiving surface 178 and/or a portion of the engaging surface 174. The thermal insulation coating 182 operates the same as the thermal insulation coating 180 as described above.

FIG. 1 is a cross-sectional view of the first sub-housing 104, illustrating a first oil cooling mechanism of the first sub-housing 104 as yet another example of the heat dissipation mechanism according to the principles of the present teachings. In some examples, the first oil cooling mechanism of the first sub-housing 104 can include a first oil path 192, a first oil inlet 194, and a first oil outlet 196 (FIGS. 2-4).

The first oil path 192 can be formed around the plurality of rotor shafts 118 and the plurality of associated first bearings 136 for lubricating the rotor shafts 118 and the first bearings 136.

The first oil inlet 194 can be arranged on the first sub-housing 104 and configured to receive and deliver a lubricant onto the rotor shafts 118 and the first bearings 136, as well as into a chamber 198 (FIG. 2) of the first sub-housing 104. The first oil inlet 194 can be in fluid communication with the first oil path 192.

In some examples, when in operation, the energy recovery device 100 can be arranged to position the first oil inlet 194 higher than the rotor shafts 118 so that the lubricant is easily delivered from the first oil inlet 194 to the rotor shafts 118 through the first oil path 192. In other examples, the first oil inlet 194 can be arranged higher than the first bearings 136. In yet other examples, the first oil inlet 194 can be arranged higher than the rotational axes A_{S} of the rotor shafts 118.

The first oil outlet 196 can be arranged on the first sub-housing 104 and configured to discharge the lubricant from the chamber 198 of the first sub-housing 104. In some examples, the first oil outlet 196 can be formed on the first sub-cap 134. The first oil outlet 196 can be arranged on a lower portion of the first sub-cap 134, as depicted in FIGS. 2-4, so that the lubricant that sinks at a lower portion of the chamber 198 by gravity is discharged conveniently. In some examples, the lubricant can be cooled down at a radiator of an associated system. In other examples, the lubricant can be cooled down with an independent oil cooler.

The first oil path 192 can be arranged between rotatory components (e.g., the plurality of meshed timing gears 120) and the engaging surface 164 of the first sub-housing 104. In addition, or alternatively, the first oil path 192 can be arranged between the first bearings 136 and the engaging surface 164. Further, the first oil outlet 196 can be arranged farther from the engaging surface 164 than the first oil path 192. Similarly, in some examples, the first oil inlet 194 can also be arranged between the rotatory components (e.g., the plurality of meshed timing gears 120) and/or the first bearings 136 and the engaging surface 164 of the first sub-housing 104. In this configuration, the oil or lubricant that is drawn into the chamber 198 of the first sub-housing 104 through the first oil inlet 194 and the first oil path 192 can operate as a heat barrier insulating heat from the main housing 102. Further, the oil can operate to absorb heat from the main housing 102 so that heat is removed from the main housing 102 and prevented from heating the components of the first sub-housing 104. The heated oil can flow toward the first oil outlet 196 that is arranged farther from the engaging surface 164 and the first oil path 192 and/or the first oil inlet 194, thereby removing the heat from the main housing 102.

In this configuration, the meshed timing gears 120 can operate as a pump. For example, the meshed timing gears 120 can agitate the lubricant contained in the chamber 198 thereof as the timing gears 120 rotate. Thus, the rotating timing gears 120 can spread the lubricant onto the entire inner surface of the chamber 198, thereby helping heat transfer from the oil to the outside of the first sub-housing 104.

The rotational speed of the timing gears 120 depends upon the speed of the device 100. For example, the rate of cooling performed by the timing gears 120 can change according to the operational speed of the device 100. Thus, the timing gears 120 does not cause either over-cooling or under-cooling, and can help optimizing the cooling of the device 100 based upon the operational status of the device 100.

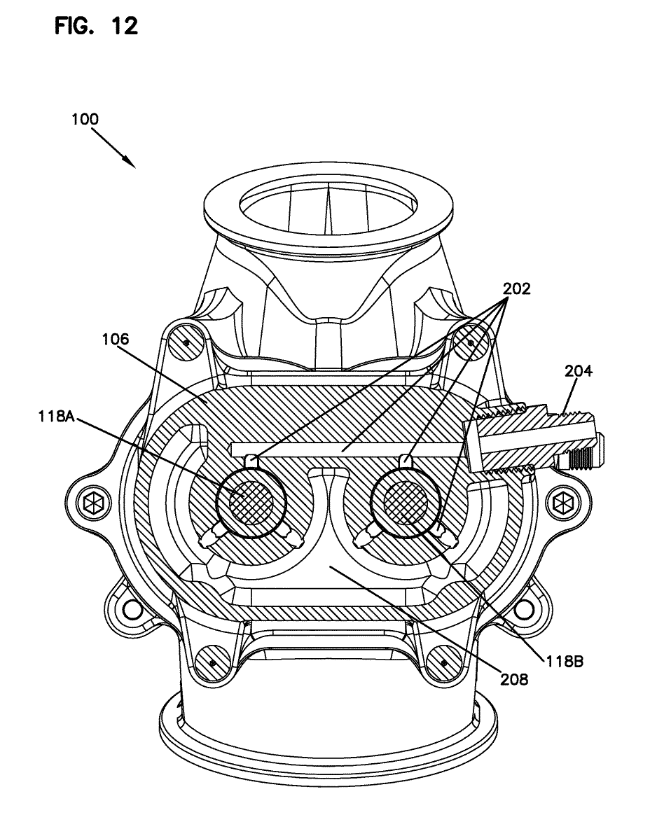

FIG. 12 is a cross-sectional view of the second sub-housing 106, illustrating a second oil cooling mechanism of the second sub-housing 106 as yet another example of the heat dissipation mechanism according to the principles of the present teachings. In some examples, the second oil cooling mechanism of the second sub-housing 106 can include a second oil path 202, a second oil inlet 204, and a second oil outlet 206 (FIGS. 2, 5 and 6).

The second oil path 202 can be formed around the plurality of rotor shafts 118 and the plurality of associated second bearings 152 for lubricating the rotor shafts 118 and the second bearings 152.

The second oil inlet 204 can be arranged on the second sub-housing 106 and configured to receive and deliver a lubricant onto the rotor shafts 118 and the second bearings 152, as well as into a chamber 208 (FIG. 2) of the second sub-housing 106. The second oil inlet 204 can be in fluid communication with the second oil path 202.

In some examples, when in operation, the energy recovery device 100 can be arranged to position the second oil inlet 204 higher than the rotor shafts 118 so that the lubricant is easily delivered from the second oil inlet 204 to the rotor shafts 118 through the second oil path 202. In other examples, the second oil inlet 204 can be arranged higher than the second bearings 152. In yet other examples, the second oil inlet 204 can be arranged higher than the rotational axes A_{S} of the rotor shafts 118.

The second oil outlet 206 can be arranged on the second sub-housing 106 and configured to discharge the lubricant from the chamber 208 of the second sub-housing 106. In some examples, the second oil outlet 206 can be formed on the second sub-cap 144. The second oil outlet 206 can be arranged on a lower portion of the second sub-cap 144, as depicted in FIGS. 2, 5 and 6, so that the lubricant that sinks at a lower portion of the chamber 208 by gravity is discharged conveniently. In some examples, the lubricant can be cooled down at a radiator of an associated system. In other examples, the lubricant can be cooled down with an independent oil cooler.

The second oil path 202 can be arranged between the second ends 124 of the rotor shafts 118 and the engaging surface 174 of the second sub-housing 106. In addition, or alternatively, the second oil path 202 can be arranged between the second bearings 152 and the engaging surface 174. Further, the second oil outlet 206 can be arranged farther from the engaging surface 174 than the second oil path 202. Similarly, in some examples, the second oil inlet 204 can also be arranged between the second ends 124 of the rotor shafts 118 and/or the second bearings 152 and the engaging surface 174 of the second sub-housing 106. In this configuration, the oil or lubricant that is drawn into the chamber 208 of the second sub-housing 106 through the second oil inlet 204 and the second oil path 202 operates as a heat barrier insulating heat from the main housing 102. Further, the oil can operate to absorb heat from the main housing 102 so that heat is removed from the main housing 102 and prevented from heating the components of the second sub-housing 106. The heated oil can flow toward the second oil outlet 206 that is arranged farther from the engaging surface 174 and the second oil path 202 and/or the second oil inlet 204, thereby removing the heat from the main housing 102.

In some examples, the second sub-housing 106 can be configured to cause the rotor shafts 118 (in particular, the output shaft 118A) to agitate the lubricant contained in the chamber 208 thereof as the rotor shafts 118 rotate. Thus, the rotating rotor shafts 118 spread the lubricant onto the entire inner surface of the chamber 208, thereby helping heat transfer from the oil to the outside of the second sub-housing 106.

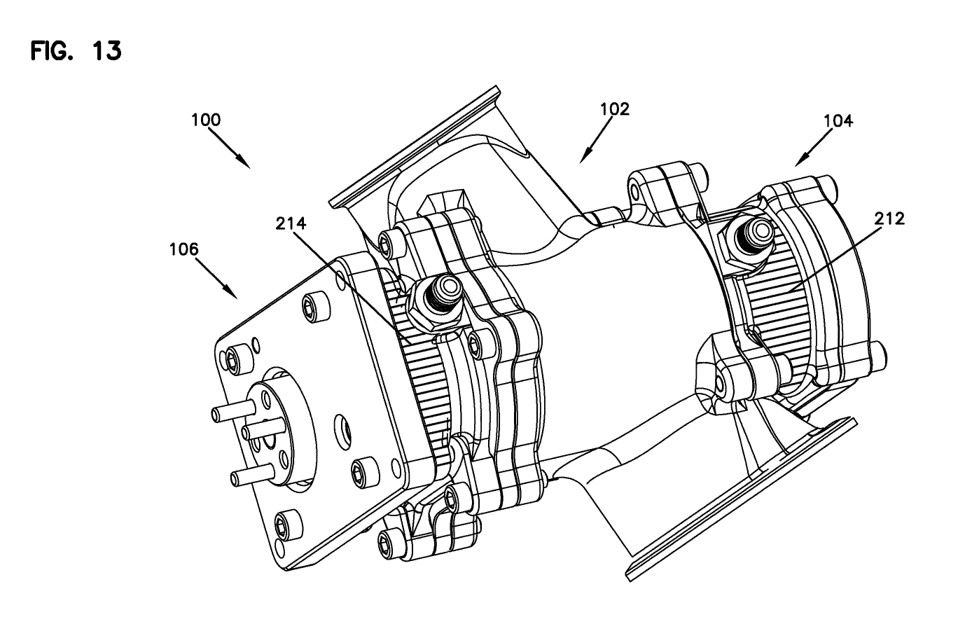

FIG. 13 illustrates finned elements 212 and 214 on the first and second sub-housings 104 and 106 as yet another example of the heat dissipation mechanism according to the principles of the present teachings.

As depicted, the first sub-housing 104 can include a first finned element 212 formed on at least portion of the outer surface of the first sub-housing 104. The first finned element 212 is a generally planar surface that extends from the outer surface of the first sub-housing 104 to increase the surface of the first sub-housing 104, thereby increasing a rate of heat transfer or dissipation from the first sub-housing 104. In some examples, the first finned element 212 can include a plurality of fins. In other examples, the first finned element 212 can be integral with the first sub-housing 104.

Similarly, the second sub-housing 106 can include a second finned element 214 formed on at least portion of the outer surface of the second sub-housing 106. The second finned element 214 is a generally planar surface that extends from the outer surface of the second sub-housing 106 to increase the surface of the second sub-housing 106, thereby increasing a rate of heat transfer or dissipation from the second sub-housing 106. In some examples, the second finned element 214 can include a plurality of fins, as shown in FIG. 13. In other examples, the second finned element 214 can be integral with the second sub-housing 106.

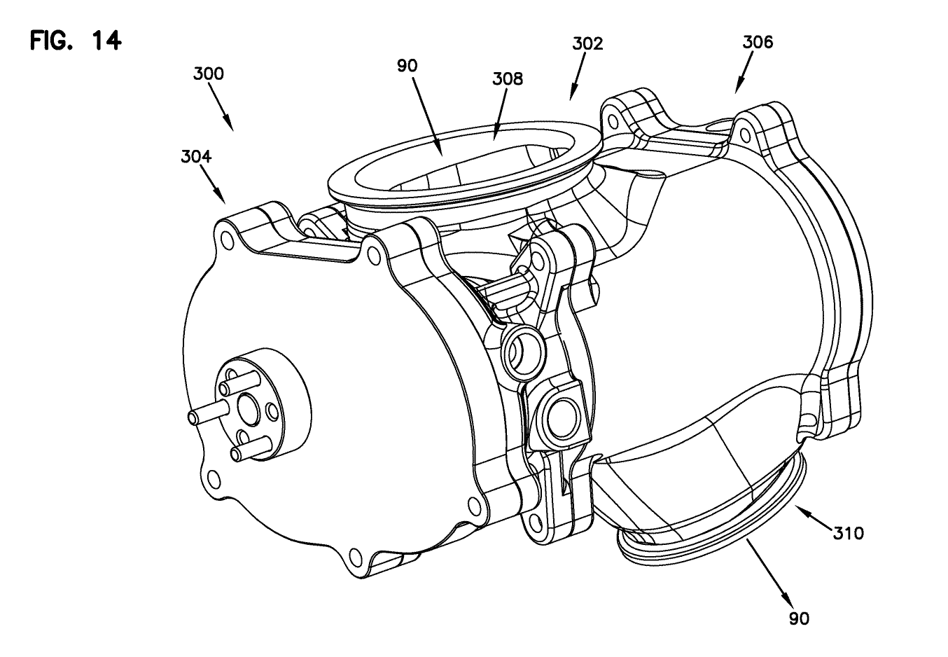

FIGS. 14-21 illustrate an example energy recovery device 300 with several heat dissipation mechanisms according to the principles of the present teachings. As many of the concepts and features are similar to the examples shown in FIGS. 1-13, the description for the examples of FIGS. 1-13 is hereby incorporated by reference for this example. Where like or similar features or elements are shown, the same or similar reference numbers will be used where possible. The following description will be limited primarily to the differences from the examples of FIGS. 1-13.

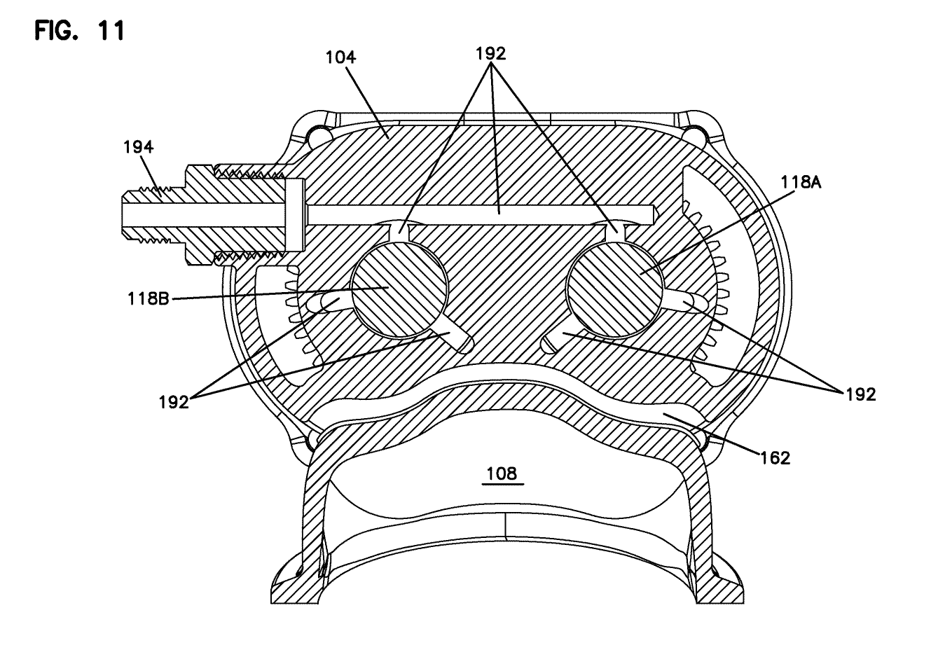

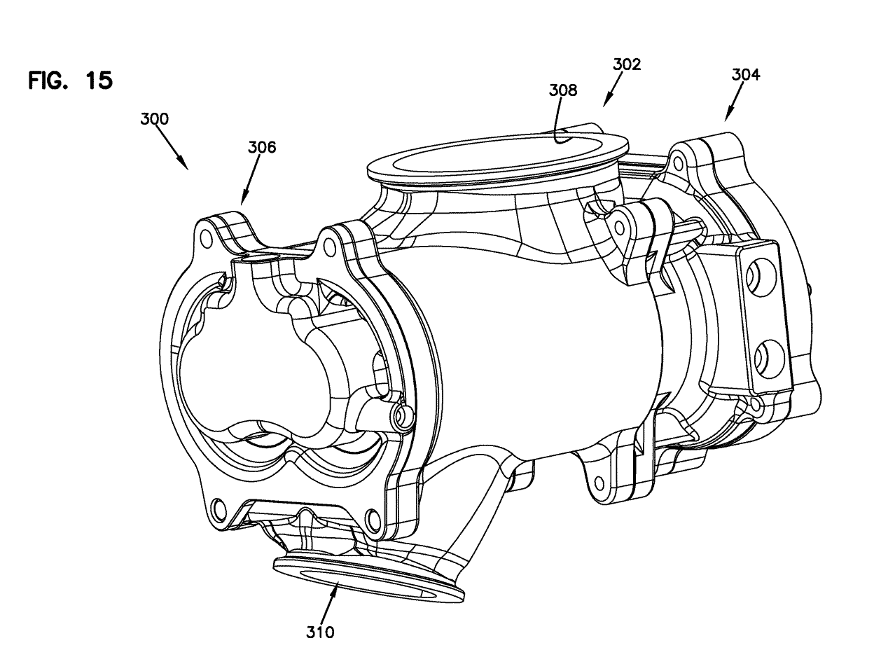

FIGS. 14 and 15 illustrate an example energy recovery device 300 with several heat dissipation mechanisms. In particular, FIG. 14 is a perspective view of an example energy recovery device 300, and FIG. 15 is another perspective view of the energy recovery device of FIG. 14. As described, the energy recovery device 300 includes at least one rotor shaft with a hollow configured as an oil channel along a rotational axis of the rotor shaft, as described hereinafter. A lubricant, such as oil or fluid, can be supplied at one end of the device 300 and is configured to flow to the other end of the device 300 through the hollow of the rotor shaft functions. The oil can help cooling the components of the device 300, as well as lubricate several rotary components disposed in the device 300. Further, the hollow formed in the rotor shaft can help reducing the mass of the rotor shaft, thereby decreasing the rotating mass of the rotor-shaft assemblies. Moreover, the hollow of the rotor shaft can reduce the number of the oil inlets and/or outlets necessary to circulate the oil through the device 300. For example, the device 300 with the hollow of the rotor shaft needs an oil inlet at one side thereof and an oil outlet at the other side thereof, whereas the example illustrated in FIGS. 11-13 requires a set of oil inlet and outlet at each side of the device 100.

In some examples, the energy recovery device 300 can further include one or more of the heat dissipation mechanisms described in FIGS. 1-13.

Referring to FIGS. 14 and 15, the energy recovery device 300 can include a main housing 302, a first sub-housing 304, and a second sub-housing 306.

Similarly to the main housing 102, the main housing 302 includes an inlet port 308 and an outlet port 310. The inlet port 308 is configured to admit the working fluid 90, and the outlet port 310 is configured to discharge the working fluid 90.

The first sub-housing 304 can be attached to the main housing 302 and configured to at least partially receive first ends 322 (e.g., 322A and 322B) of a plurality of rotor shafts 318 (e.g., 318A and 318B) and a plurality of meshing rotary components 320 (e.g., 320A and 320B) (FIG. 15). As described below, the meshed rotary components 320 can be rotatably disposed within the first sub-housing 304. An example configuration associated with the first sub-housing 304 is described and illustrated with reference to FIGS. 15-17.

The second sub-housing 306 can be attached to the main housing 302 and configured to at least partially receive second ends 324 (e.g., 324A and 324B) of the plurality of rotor shafts 318 (e.g., 318A and 318B). As described below, the second ends 324 of the plurality of rotor shafts 318 can be rototably disposed within the second sub-housing 306. An example configuration associated with the second sub-housing 306 is described and illustrated with reference to FIGS. 15, and 18-20.

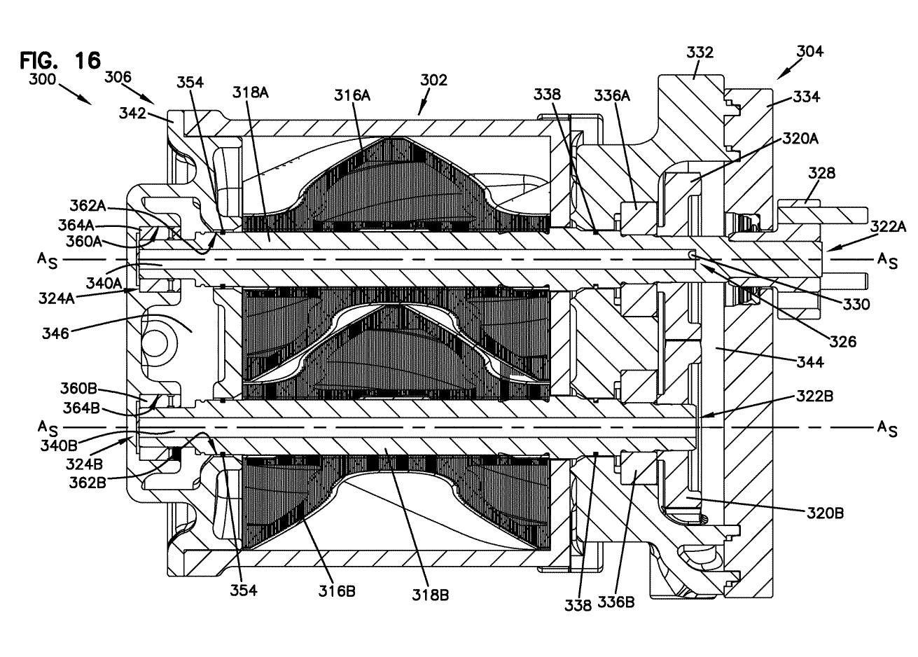

FIG. 16 is a cross-sectional view of the energy recovery device 300 of FIG. 14. The energy recovery device 300 can include a plurality of rotors 316, a plurality of rotor shafts 318, and a plurality of rotary components 320.

Similarly to the plurality of rotors 116, the plurality of rotors 316 (e.g., 316A and 316B) can be rotatably disposed in the main housing 302. The configuration and operation of the rotors 316 are the same as, or substantially similar to, the rotors 116.

The plurality of rotor shafts 318 (e.g., 318A and 318B) can be associated with the plurality of rotors 316. In some examples, each of the plurality of rotor shafts 318 can be fixed to each rotor 316. In other examples, each rotor shaft 318 can be integrally formed with each rotor 316. The plurality of rotor shafts 318 can have first and second ends 322 (e.g., 322A and 322B) and 324 (e.g., 324A and 324B) and can extend along an axis of rotation A_{S}. As described below, the rotor shafts 318 can extend from the main housing 302 and can be rotatably supported by the first sub-housing 304 at the first ends 322. Further, the rotor shafts 318 can extend from the main housing 302 and can be rotatably supported by the second sub-housing 306 at the second ends 324.

In the depicted example, the energy recovery device 300 can have two rotor shafts 318A and 318B (collectively, 318) that can be fixed to the two rotors 316A and 316B (collectively, 316), respectively. One of the rotors shafts 318 can be an output shaft 318A through which a mechanical work is generated. The first end 322A of the output shaft 318A can engage a driving head 328 rotatably supported by the first sub-housing 306. The driving head 328 can be configured to engage a power transmission mechanism (not shown) for delivering the mechanical work from the rotating output shaft 318A. In other examples, however, the driving head 328 can be engaged with the second end 324A of the output shaft 318A and rotatably supported by the second sub-housing 306.

In some examples, the rotor shafts 118 can include first sealing elements 338 engaged therearound at or adjacent the first ends 122. The first sealing elements 338 can be arranged between the main housing 302 and the first bearings 336 and configured to provide sealing around the rotors shafts 318 that are rotatably disposed in the first sub-housing 304. Examples of the first sealing elements 338 include O-rings and turbo seal rings.

The rotor shafts 318 include a hollow 340 (e.g., 340A and 340B) at least partially extending between the first and second ends 322 and 324 and configured to enable an oil to flow therethrough. The hollow 340 is in fluid communication with a first interior 344 of the first sub-housing 304 at the first end 322 and with a second interior 346 of the second sub-housing 306 at the second end 324. As described herein, an oil that is supplied to the second interior 346 can flow into the hollow 340 at the second end 324, pass through the hollow 340 along the axis of rotation of the rotor shafts 318, and exit at the first end 322 into the first interior 344. In other examples, the oil can flow in the opposite direction. In some examples, the device 300 can be configured such that the oil can be supplied directly to the hollow 340 of the rotor shafts 318 from an outside source, and/or can be discharged directly from the hollow 304 of the rotor shafts 318 outside the device 300.

In some examples, the hollow 340 can be provided to at least part of the length of the rotor shafts 318. For example, the hollow 340B is formed through the entire length of the rotor shaft 318B so that the both ends of the hollow 340B are open at the first and second ends 322B and 324B and directly exposed to the first and second interiors 344 and 346. Where the rotor shaft 318 is the output shaft 318A configured to engage the driving head 328 at the first end 322A, the hollow 340A of the rotor shaft 318A can be configured to extend from the second end 324A to a closed end 326 adjacent the first end 322A. For example, the hollow 340A is open at the second end 324A and exposed to the second interior 346 of the second sub-housing 306. The hollow 304A is closed at the closed end 326 adjacent the first end 322A. The rotor shaft 318A includes a port 330 arranged at the closed end 326 and configured to provide fluid communication between the hollow 340A and the first interior 344 of the first sub-housing 304.

The plurality of rotary components 320 (e.g., 320A and 320B) can be rotatably disposed in the first sub-housing 304 (i.e., the first interior 344 thereof) and coupled to the plurality of rotor shafts 318, respectively. In some examples, the rotary components 320 include timing gears that are meshed each other within the first sub-housing 304.

In some examples, the energy recovery device 300 can further include a plurality of first bearings 336 (e.g., 336A and 336B) configured to be mounted into the first sub-housing 304 and configured to rotatably support the rotors shafts 318, respectively.

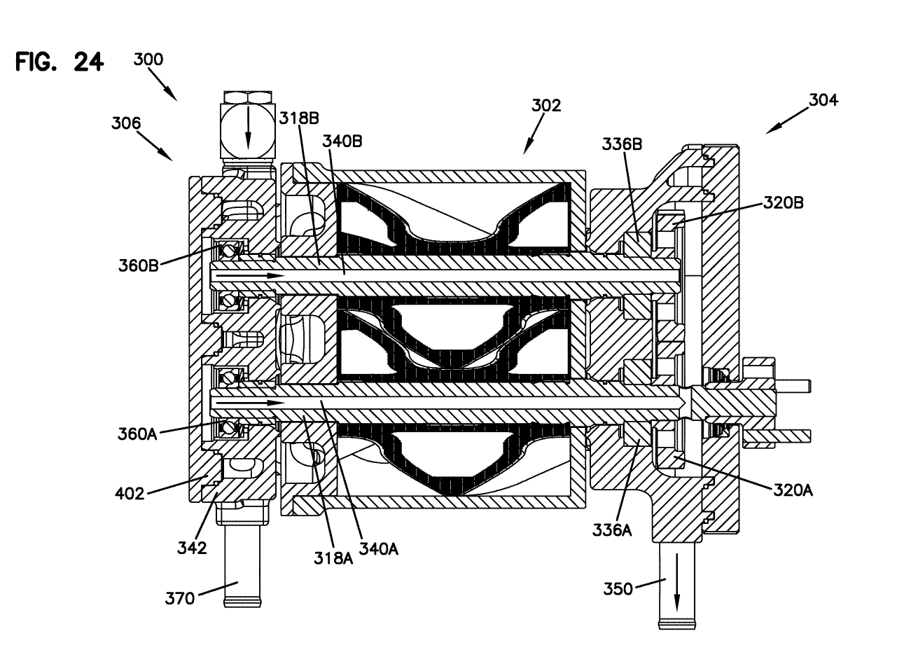

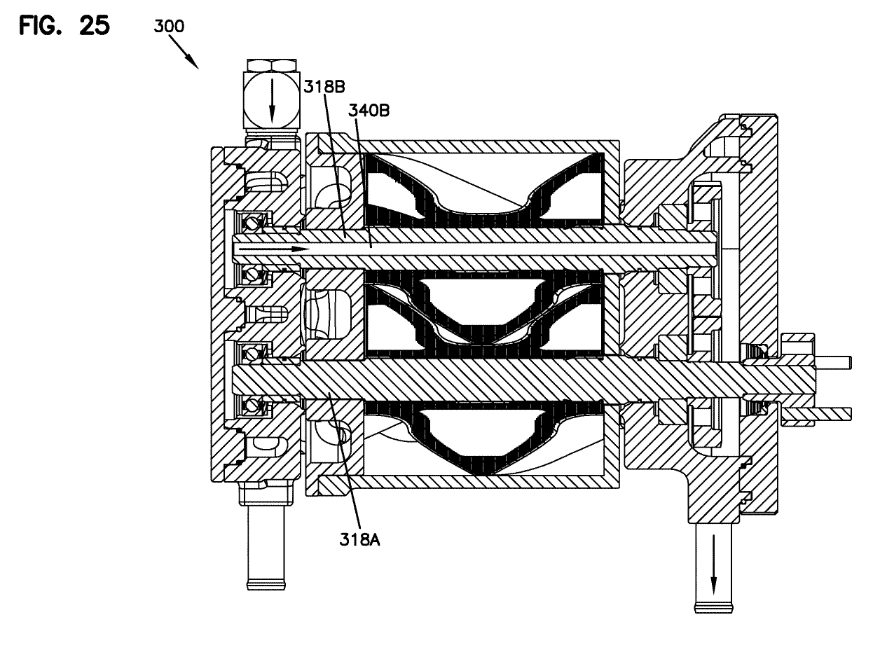

In some examples, the energy recovery device 300 can further include a plurality of second bearings 360 (e.g., 360A and 360B) disposed in the second sub-housing 306. The plurality of second bearings 360 is configured to rotatably support the rotor shafts 318 at the second end 324 within the second sub-housing 306. In some examples, the second bearings 360 are configured as plain bearings. Examples of the plain bearings include bushings. The bushing is a type of plain bearing and configured to provide a bearing surface for rotary applications without additional rotary components such as balls. The bushing can be configured as a sleeve of material with an inner diameter, outer diameter, and length. In other examples, the second bearings 360 can include ball bearings (FIGS. 24 and 25).

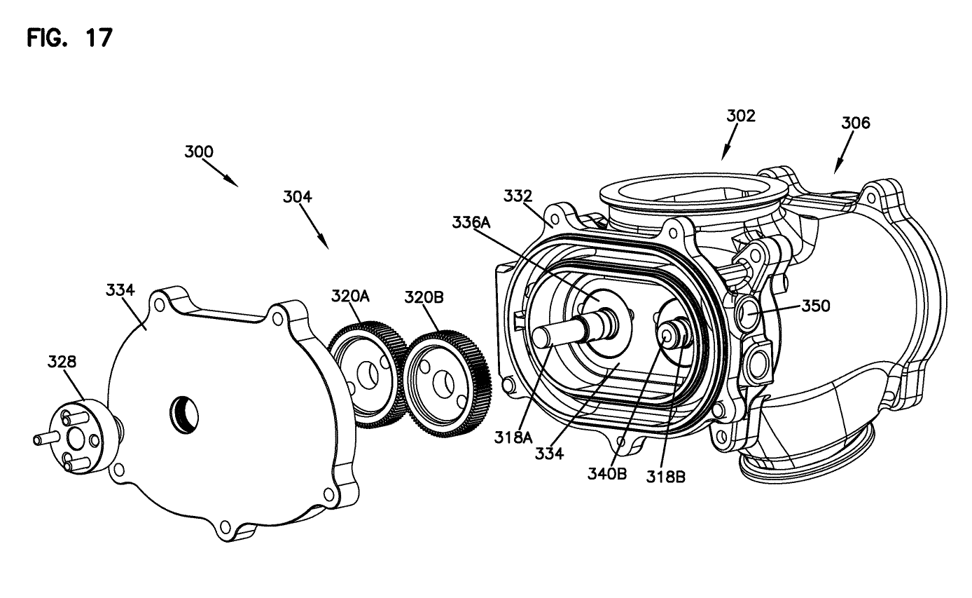

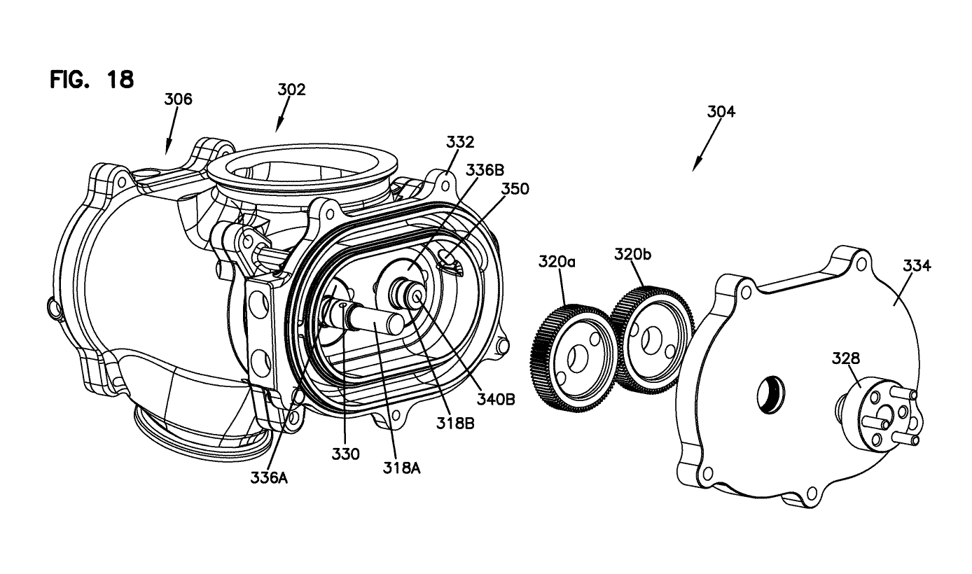

FIGS. 17 and 18 are expanded views of the first sub-housing 304. Referring to FIGS. 15-17, in some examples, the first sub-housing 304 can include a first sub-body 332 and a first sub-cap 334.

The first sub-body 332 can be configured to rotatably support a portion of the rotor shafts 318 at the first end 322 when attached to the main housing 302. As described, the plurality of first bearings 336 and the plurality of rotary components 320 are disposed within the first sub-body 332.

The first sub-cap 334 can be configured to cover the first sub-body 332 to define the first interior 334 of the first sub-housing 304 so that the first bearings 336, the rotary components 320, and other associated components are disposed in the first sub-body 332.

As depicted in FIGS. 17 and 18, the first sub-housing 304 can further include an oil outlet 350. In some examples, the oil outlet 350 is provided at the first sub-body 332. The oil outlet 350 is configured to be in fluid communication with the first interior 334 of the first sub-housing 304 so that the oil contained in the first interior 334 is drawn out through the oil outlet 350. In other examples, the oil outlet 350 can be used as an inlet for supplying the oil into the first interior 334 of the first sub-housing 304.

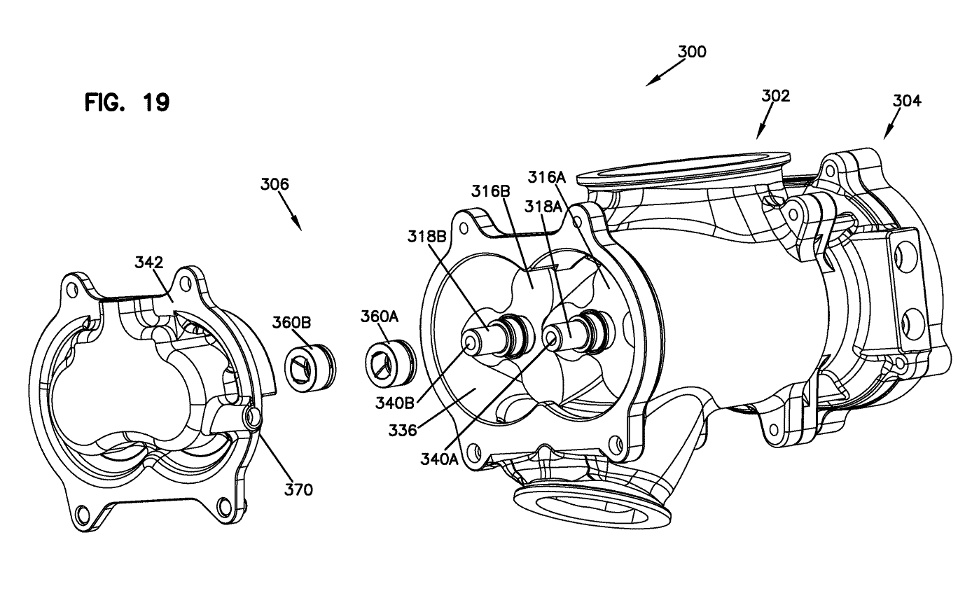

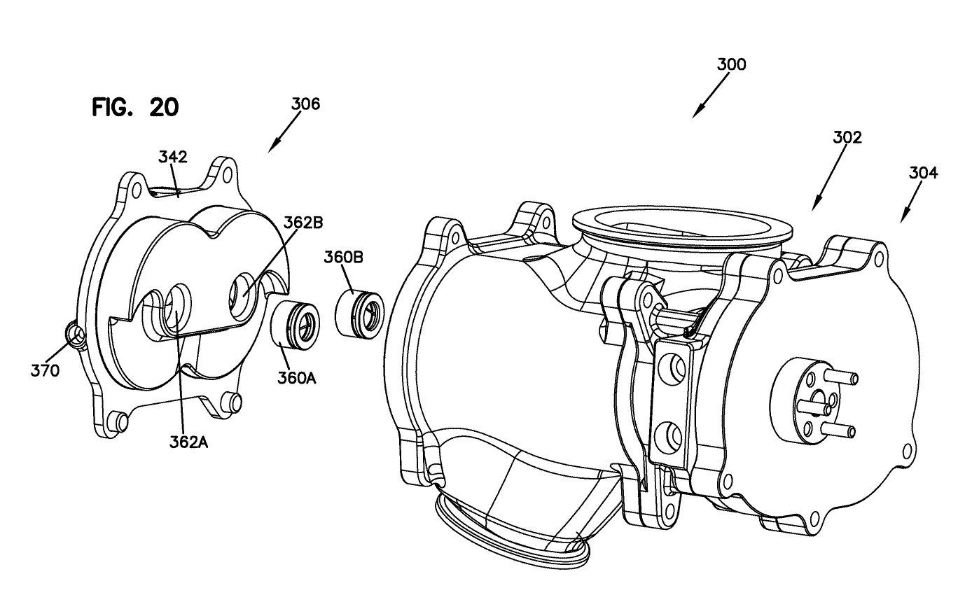

FIGS. 19 and 20 are expanded views of the second sub-housing 306.

Referring to FIGS. 15, 19 and 20, in some examples, the second sub-housing 306 can include a second sub-body 342 configured to be attached to the main housing 302.

The second sub-body 342 is configured to rotatably support a portion of the rotor shafts 318 at the second ends 324 when attached to the main housing 302. The second sub-body 342 can be configured to cover the main housing 302 to define a chamber in which the rotors 316 are rotatably disposed.

The second sub-body 342 is configured to define the second interior 346 of the second sub-housing 306. The second sub-body 342 is also configured to receive the plurality of second bearings 360, which is disposed in the second interior 346 and configured to rotatably support the rotor shafts 318 at the second end 324. In some examples, the second sub-body 342 includes a plurality of bearing receiving portions 364 (e.g., 364A and 364B) configured to receive the plurality of second bearings 360 therein, respectively.

As depicted in FIG. 20, the second sub-body 342 includes a plurality of bores 362 (e.g., 362A and 362B) configured to rotatably engage a portion of the rotor shafts 318 therearound. The plurality of bores 362 is coaxially arranged with the plurality of bearing receiving portions 364. The rotor shafts 318 can include a plurality of second sealing elements 354 (e.g., 354A and 354B) engaged therearound at or adjacent the second end 324 such that the second sealing elements 354 provide sealing around the rotor shafts 318 against the bores 362 of the second sub-body 342. Examples of the second sealing elements 354 include O-rings and turbo seal rings.

As depicted in FIGS. 19 and 20, the second sub-housing 306 can further include an oil inlet 370. In some examples, the oil inlet 370 is provided at the second sub-body 342. The oil inlet 370 is configured to be in fluid communication with the second interior 346 of the second sub-housing 306 so that the oil is supplied into the second interior 346 and flow into the hollow 340 of the rotor shafts 318. In other examples, where the oil outlet 350 is used as an inlet, the oil inlet 370 can be used as an outlet for discharging the oil from the second interior 346 of the second sub-housing 306.

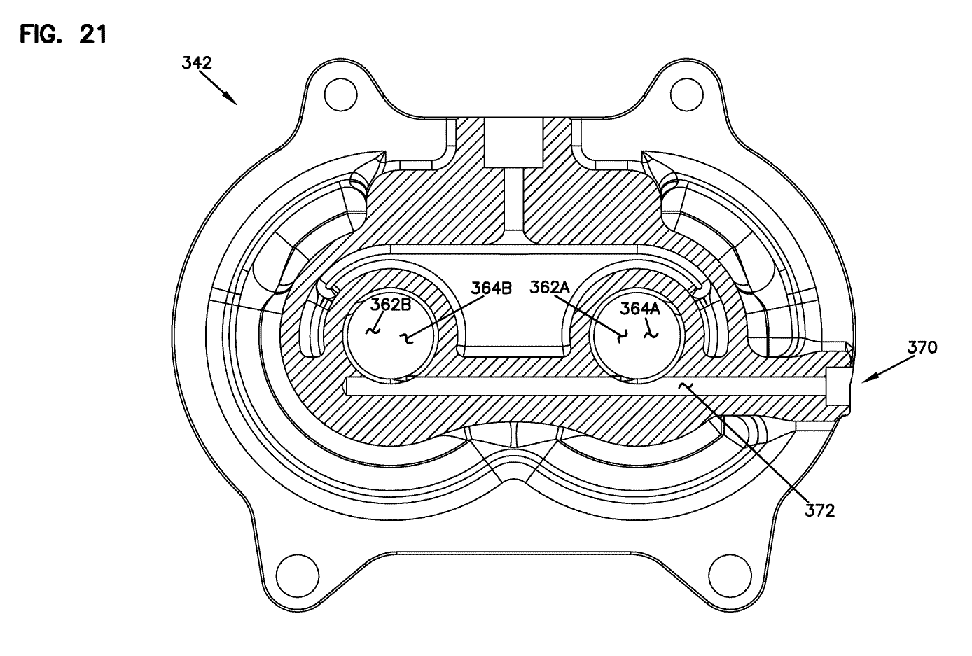

FIG. 21 is a cross-sectional view of the second sub-housing 306. In some examples, the oil inlet 370 is configured to be in fluid communication with the plurality of bearing receiving portions 364 of the second sub-body 342. For example, the second sub-body 342 includes a channel 372 connecting the oil inlet 370 and the plurality of bearing receiving portions 364. As depicted in FIG. 16, the second bearings 360 are mounted into the bearing receiving portions 364 and the rotor shafts 318 are rotatably supported by the second bearings 360 while the hollows 340 are exposed at the second ends 324. The second ends 324 of the rotor shafts 318 are arranged adjacent the channel 372 such that at least part of the oil supplied from the oil inlet 370 flows into the hollows 340 of the rotor shafts 318.

In some example, a lubricant or oil can be supplied from the oil inlet 370 and flow into the hollow 340 at the second end 324 through the channel 372. At least part of the oil can also flow between the second bearing 360 and the rotor shaft 318 to lubricate the rotating rotor shaft 318, and flow into the second interior 346 of the second sub-housing 306 to lubricate rotary components disposed in the second sub-housing 306. The oil flowing into the hollow 340 continues to flow through the hollow 340 of the rotor shaft 318 along the axis of rotation thereof. The oil passing through the hollow 340 across the length of the rotor shaft 318 flows into the first interior 344 of the first sub-housing 304. The oil can lubricate several rotary components disposed in the first sub-housing 304. In this configuration, the meshed timing gears 320 can operate as a pump. For example, the meshed timing gears 320 can agitate the oil contained in the first interior 344 thereof as the timing gears 320 rotate. Thus, the rotating timing gears 320 can spread the oil onto the entire inner surface of the first interior 344, thereby helping heat transfer from the oil to the outside of the first sub-housing 304. The oil contained in the first sub-housing 304 can be discharged through the oil outlet 350.

The rotational speed of the timing gears 320 depends upon the speed of the device 100. For example, the rate of cooling performed by the timing gears 320 can change according to the operational speed of the device 300. Thus, the timing gears 320 does not cause either over-cooling or under-cooling, and can help optimizing the cooling of the device 300 based upon the operational status of the device 300.

In this example, the device 300 includes multiple housings (e.g., the main housing 302 and the first and second sub-housings 304 and 306) that are assembled together. In other examples, however, the device 300 include a single housing that functions as the assembly of the main housing 302, the first sub-housing 304 and the second sub-housing 306. Such a single housing may have one or more caps or covers that are attached to either or both sides of the housing.

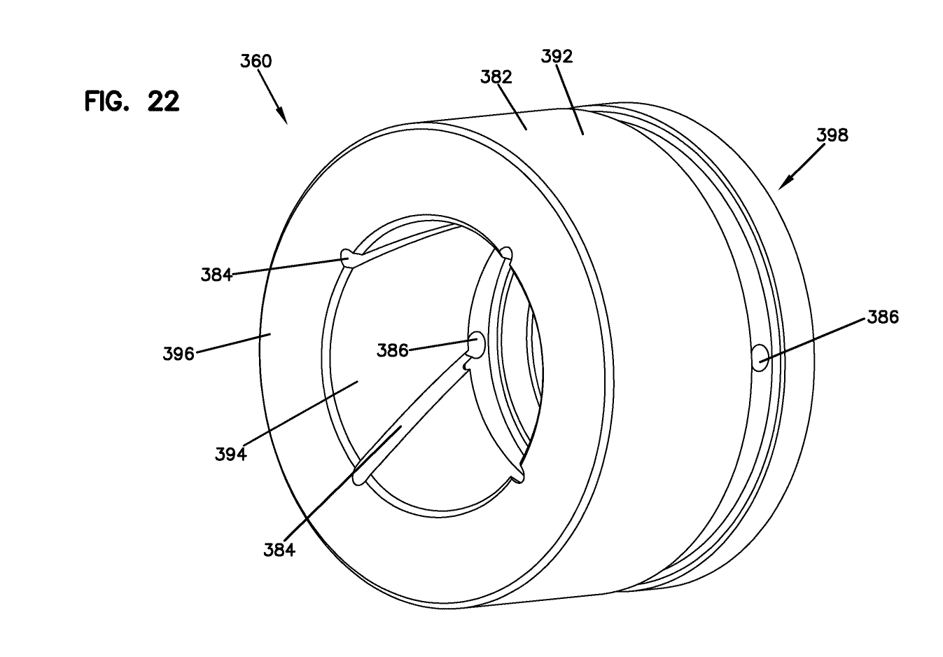

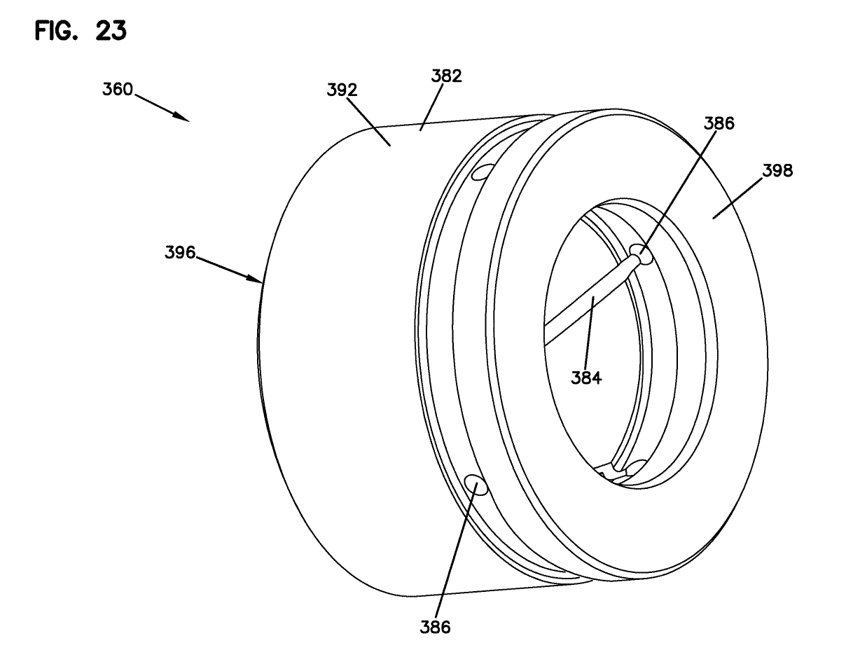

FIGS. 22 and 23 illustrate an example second bearing 360. In some examples, the second bearings 360 are configured as plain bearings, such as bushings.

As depicted, the second bearing 360 includes a bearing body 382, one or more oil grooves 384, and one or more oil holes 386.

The bearing body 382 can be cylindrically shaped to engage the rotor shaft 318 at the second end 324. The bearing body 382 has an outer surface 392, an inner surface 394, a first surface 396, and a second surface 398. The outer surface 392 is configured to engage the bearing receiving portion 364 of the second sub-housing 306. The inner surface 394 is configured to rotatably engage a portion of the rotor shaft 318 at the second end 324. The first surface 396 is arranged to be adjacent the channel 372 when the bearing body 382 is engaged into the bearing receiving portion 364. The second surface 398 is arranged opposite to the first surface 396.

The oil grooves 384 are formed on the inner surface 394 of the bearing body 382 and extend from the first surface 396 to the oil holes 386. The oil grooves 384 are configured to enable the oil supplied from the oil inlet 370 to flow therealong, thereby lubricating an outer surface of the rotor shaft 318 that is rotatably engaged with the inner surface 394 of the bearing body 382.

The oil holes 386 are formed to pass through the bearing body 382 between the outer and inner surfaces 392 and 394, and arranged adjacent one end of the oil grooves 384 opposite to the first surface 396. The oil holes 386 provide a passage through which the oil used to lubricate the rotating rotor shaft 318 is drained from a space between the inner surface 394 and the engaging outer surface of the rotor shaft 318.

FIG. 24 is a cross-sectional view of another example energy recovery device 300 according to the principles of the present teachings. As many of the concepts and features are similar to the examples shown in FIGS. 14-21, the description for the examples of FIGS. 14-21 is hereby incorporated by reference for this example. Where like or similar features or elements are shown, the same or similar reference numbers will be used where possible. The following description will be limited primarily to the differences from the examples of FIGS. 14-21.

In this example, the energy recovery device 300 includes the second sub-housing 306 having the second sub-body 342 and a second sub-cap 402. In particular, the second sub-housing 306 is made by assembling the second sub-cap 402 onto the second sub-body 342. Further, the second bearings 360 (e.g., 360A and 360B) are configured as ball bearings.

FIG. 25 is a cross-sectional view of yet another example energy recovery device 300 according to the principles of the present teachings. As many of the concepts and features are similar to the examples shown in FIGS. 14-21 and 24, the description for the examples of FIGS. 14-21 and 24 is hereby incorporated by reference for this example. Where like or similar features or elements are shown, the same or similar reference numbers will be used where possible. The following description will be limited primarily to the differences from the examples of FIGS. 14-21 and 24.

In this example, the hollow 340 is formed in only one of two rotor shafts 318 (e.g., 318A and 318B). In the depicted example, the rotor shaft 318A (i.e., the output shaft) does not have the hollow 340A therein while the other rotor shaft 3188B includes the hollow 340B therein. In other examples, the rotor shaft 318A may have the hollow 340A while the other rotor shaft 318B does not have the hollow 340B.

In some examples, the heat dissipation mechanisms, as described herein (FIGS. 1-25), can be independently used in the energy recovery device 100 and 300. In other examples, the energy recovery device 100 and 300 can incorporate all or any combination of the heat dissipation mechanisms as described herein.

### Energy Recovery Device Applications

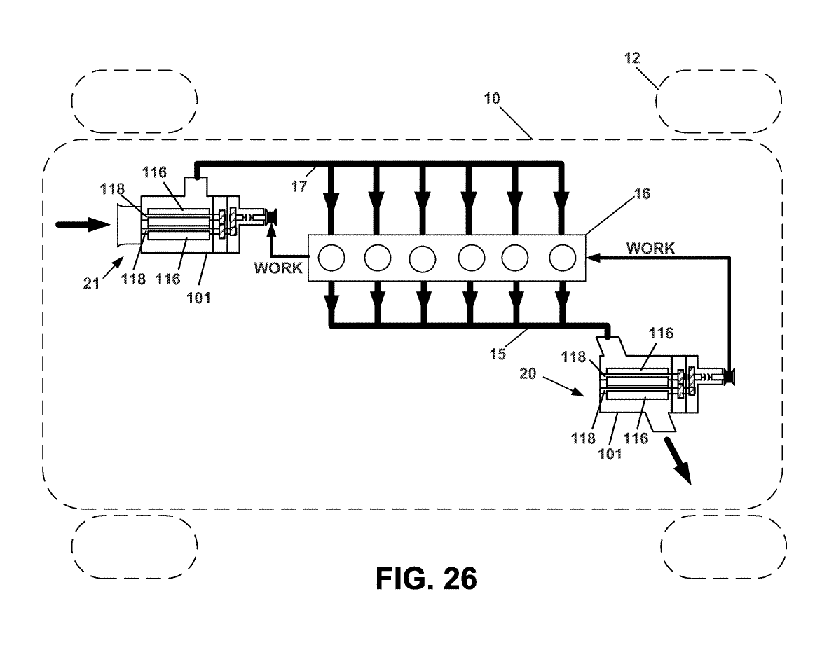

The above energy recovery device 100 may be used in a variety of applications. One example application can be for use in a fluid expander 20 and/or a compression device 21, as shown in FIG. 26. For example, the fluid expander 20 and the compression device 21 are volumetric devices through which the fluid passes across the rotors 116. FIG. 26 shows the expander 20 and a compression device 21 (e.g., a supercharger) being provided in a vehicle 10 having wheels 12 for movement along an appropriate road surface. The vehicle 10 includes a power plant 16 that receives intake air 17 and generates waste heat in the form of a high-temperature exhaust gas in exhaust 15. In some examples, the power plant 16 can be an internal combustion engine. In other examples, the power plant 16 can be a fuel cell. The rotor assembly 116 may also be used as a straight or helical gear (i.e. a rotary component) in a gear train, as a rotor in other types of expansion and compression devices, as an impeller in pumps, and as a rotor in mixing devices.

As shown in FIG. 12, the expander 20 can receive heat from the power plant exhaust 15 and can convert the heat into useful work which can be delivered back to the power plant 16 (electrically and/or mechanically) to increase the overall operating efficiency of the power plant. As configured, the expander 20 can include a housing 101 (e.g., an assembly of the main housing 102, the first sub-housing 104, and the second sub-housing 106) within which a pair of rotor assemblies 116 is disposed. The expander 20 having rotor assemblies 116 can be configured to receive heat from the power plant 16 directly or indirectly from the exhaust.

One example of a fluid expander 20 that directly receives exhaust gases from the power plant 16 is disclosed in Patent Cooperation Treaty (PCT) International Application Number PCT/US2013/078037 entitled EXHAUST GAS ENERGY RECOVERY SYSTEM. PCT/US2013/078037 is herein incorporated by reference in its entirety.

One example of a fluid expander 20 that indirectly receives heat from the power plant exhaust via an organic Rankine cycle is disclosed in Patent Cooperation Treaty (PCT) International Application Publication Number WO 2013/130774 entitled VOLUMETRIC ENERGY RECOVERY DEVICE AND SYSTEMS. WO 2013/130774 is incorporated herein by reference in its entirety.

Still referring to FIG. 26, the compression device 21 can be shown provided with a housing 101 within which a pair of rotor assemblies 116 is disposed. As configured, the compression device can be driven by the power plant 16. As configured, the compression device 21 can increase the amount of intake air 17 delivered to the power plant 16. In one example, compression device 21 can be a Roots-type blower of the type shown and described in U.S. Pat. No. 7,488,164 entitled OPTIMIZED HELIX ANGLE ROTORS FOR ROOTS-STYLE SUPERCHARGER. U.S. Pat. No. 7,488,164 is hereby incorporated by reference in its entirety.

The various examples described above are provided by way of illustration only and should not be construed to limit the claims attached hereto. Those skilled in the art will readily recognize various modifications and changes that may be made without following the example examples and applications illustrated and described herein, and without departing from the true spirit and scope of the following claims.

What is claimed is:

1. An energy recovery device comprising:
a main housing having inlet and outlet ports and a first receiving surface, the inlet port configured to admit a working fluid, and the outlet port configured to discharge the working fluid;
a plurality of rotors rotatably disposed in the main housing;
a plurality of rotor shafts associated with the plurality of rotors, respectively;
a first sub-housing having an engaging surface and being attached to the main housing; and
a plurality of rotatory components rotatably disposed in the first sub-housing and operatively coupled to the plurality of rotor shafts, respectively,
wherein at least part of the engaging surface of the first sub-housing faces and is spaced apart from the first receiving surface of the main housing with a first gap therebetween.

2. The energy recovery device according to claim 1, further comprising a second sub-housing having an engaging surface and being attached to the main housing,
wherein the main housing includes a second receiving surface, and
wherein at least part of the engaging surface of the second sub-housing is spaced apart the second receiving surface of the main housing with a second gap therebetween.

3. The energy recovery device according to claim 2, wherein:
each of the plurality of rotor shafts has first and second ends along an axis of rotation;
the plurality of rotatory components is fixed to the plurality of rotor shaft at the first ends, respectively; and
the second sub-housing is configured to rotatably support the plurality of rotor shafts at the second ends.

4. The energy recovery device according to any of claims 1-3, wherein the first sub-housing includes at least one first projection extending from the engaging surface of the first sub-housing, the at least one first projection having a first height equal to the first gap when the first sub-housing is attached to the main housing.

5. The energy recovery device according to any of claims 2-4, wherein the second sub-housing includes at least one second projection extending from the engaging surface of the second sub-housing, the at least one second projection having a second height equal to the second gap when the second sub-housing is attached to the main housing.

6. The energy recovery device according to any of claims 1-5, wherein a thermal insulation coating is provided on at least one of the first receiving surface and the engaging surface of the first sub-housing.

7. The energy recovery device according to any of claims 2-6, wherein a thermal insulation coating is provided on at least one of the second receiving surface and of the engaging surface of the second sub-housing.

8. The energy recovery device according to any of claims 1-7, wherein the first sub-housing comprises:
a plurality of first bearings supporting the plurality of rotor shafts therein;
a first oil path provided around the plurality of first bearings;
a first oil inlet arranged on the first sub-housing and configured to receive a lubricant, the first oil inlet being in fluid communication with the first oil path; and
a first oil outlet arranged on the first sub-housing and configured to discharge the lubricant, the first oil outlet being in fluid communication with the first oil path,
wherein the first oil path is arranged between the plurality of rotatory components and the engaging surface of the first sub-housing, and
wherein the first oil outlet is arranged at a first distance from the engaging surface of the first sub-housing, the first distance greater than a second distance between the engaging surface of the first sub-housing and the first oil path.

9. The energy recovery device according to any of claims 2-8, wherein the second sub-housing comprises:
a plurality of second bearings supporting the plurality of rotor shaft therein;
a second oil path provided around the plurality of second bearings;
a second oil inlet arranged on the second sub-housing and configured to receive a lubricant, the second oil inlet being in fluid communication with the second oil path; and
a second oil outlet arranged on the second sub-housing and configured to discharge the lubricant, the second oil outlet being in fluid communication with the second oil path,
wherein the second oil path is arranged between the second ends of the plurality of rotor shafts and the engaging surface of the second sub-housing, and
wherein the second oil outlet is arranged at a first distance from the engaging surface of the second sub-housing, the first distance greater than a second distance between the engaging surface of the second sub-housing and the second oil path.

10. The energy recovery device according to any of claims 1-9, wherein the plurality of rotatory components is a plurality of meshed timing gears.

11. The energy recovery device according to any of claims 1-10, wherein the working fluid is an exhaust gas stream from a power plant.

12. The energy recovery device according to claim 11, wherein the power plant is an internal combustion engine.

13. The energy recovery device according to any of claims 1-12, wherein at least one of the plurality of rotor shafts comprises a hollow extending along at least part of a length thereof, the hollow configured to enable an oil to flow therethrough.

14. The energy recovery device according to any of claims 2-12,
wherein at least one of the plurality of rotor shafts comprises a hollow extending along at least part of a length thereof, the hollow configured to enable an oil to flow therethrough;
wherein the first sub-housing comprises an oil outlet being in fluid communication with the hollow and configured to discharge the oil; and
wherein the second sub-housing comprises an oil inlet being in fluid communication with the hollow and configured to receive the oil.

15. The energy recovery device according to claim 2-12,
wherein at least one of the plurality of rotor shafts comprises a hollow at least partially extending between the first and second ends along the axis of rotation, the hollow configured to be in fluid communication with an interior of the first sub-housing at the first end and in fluid communication with an interior of the second sub-housing at the second end to enable an oil to flow between the interiors of the first and second sub-housings;
wherein the first sub-housing comprises an oil outlet being in fluid communication with the interior of the first sub-housing and configured to discharge the oil therefrom; and
wherein the second sub-housing comprises an oil inlet being in fluid communication with the interior of the second sub-housing and configured to receive the oil therein.

16. The energy recovery device according to any of claims 4-15, wherein the at least first projection is configured to have a first initial height before the first sub-housing is attached to the main housing, the first initial height greater than the first gap.

17. The energy recovery device according to any of claim 5-16, wherein the at least second projection is configured to have a second initial height before the second sub-housing is attached to the main housing, the second initial height greater than the second gap.

18. The energy recovery device according to any of claims 1-17, wherein the first sub-housing includes at least one finned element configured to increase a rate of heat transfer.

19. The energy recovery device according to any of claims 2-18, wherein the second sub-housing includes at least one finned element configured to increase a rate of heat transfer.

20. The energy recovery device according to any of claim 8-19, wherein the energy recovery device is arranged, when in use, to position the first oil inlet higher than rotational axes of the plurality of rotor shafts.

21. The energy recovery device according to any of claim 8-20, wherein the plurality of rotatory components operates as a pump to agitate the lubricant within the first sub-housing.

22. The energy recovery device according to any of claim 9-21, wherein the energy recovery device is arranged, when in use, to position the second oil inlet higher than rotational axes of the plurality of rotor shafts.

23. The energy recovery device according to any of claim 9-22, further comprising at least one plain bearing configured to rotatably support at least one of the rotor shafts at the second end thereof within the second sub-housing.

24. An energy recovery device comprising:
a main housing having inlet and outlet ports and a first receiving surface, the inlet port configured to admit a working fluid, and the outlet port configured to discharge the working fluid;
a plurality of rotors rotatably disposed in the main housing;
a plurality of rotor shafts associated with the plurality of rotors, respectively; and
a first sub-housing having an engaging surface, the engaging surface of the first sub-housing engaged with the first receiving surface of the main housing,
wherein a thermal insulation coating is provided on at least one of the first receiving surface of the main housing and the engaging surface of the first sub-housing.

25. The energy recovery device according to claim 24, further comprising a second sub-housing having an engaging surface and attached to the main housing, wherein:
the main housing includes a second receiving surface configured to engage the engaging surface of the second sub-housing,
each of the plurality of rotor shafts has first and second ends along an axis of rotation;
the first sub-housing is configured to rotatably support the plurality of rotor shafts at the first ends;
the second sub-housing configured to rotatably support the plurality of rotor shafts at the second ends; and
a thermal insulation coating is provided on at least one of the second receiving surface of the main housing and the engaging surface of the second sub-housing.

26. An energy recovery device comprising:
a main housing having inlet and outlet ports and a first receiving surface, the inlet port configured to admit a working fluid, and the outlet port configured to discharge the working fluid;
a plurality of rotors rotatably disposed in the main housing;
a plurality of rotor shafts associated with the plurality of rotors, respectively; and
a first sub-housing having an engaging surface, the engaging surface of the first sub-housing engaged with the first receiving surface of the main housing, the first sub-housing further comprising:
a plurality of first bearings supporting the plurality of rotor shafts therein;
a first oil path provided around the plurality of first bearings;
a first oil inlet arranged on the first sub-housing and configured to receive a lubricant, the first oil inlet being in fluid communication with the first oil path; and
a first oil outlet arranged on the first sub-housing and configured to discharge the lubricant, the first oil outlet being in fluid communication with the first oil path,
wherein the first oil path is arranged between the plurality of rotatory components and the engaging surface of the first sub-housing, and
wherein the first oil outlet is arranged at a first distance from the engaging surface of the first sub-housing, the first distance greater than a second distance between the engaging surface of the first sub-housing and the first oil path.

27. The energy recovery device according to claim 26, further comprising a second sub-housing having an engaging surface and attached to the main housing, wherein:
the main housing includes a second receiving surface configured to engage the engaging surface of the second sub-housing,
each of the plurality of rotor shafts has first and second ends along an axis of rotation;
the first sub-housing is configured to rotatably support the plurality of rotor shafts at the first ends;
the second sub-housing configured to rotatably support the plurality of rotor shafts at the second ends; and
the second sub-housing comprises:
a plurality of second bearings supporting the plurality of rotor shaft therein;
a second oil path provided around the plurality of second bearings;
a second oil inlet arranged on the second sub-housing and configured to receive a lubricant, the second oil inlet being in fluid communication with the second oil path; and
a second oil outlet arranged on the second sub-housing and configured to discharge the lubricant, the second oil outlet being in fluid communication with the second oil path,
wherein the second oil path is arranged between the second ends of the plurality of rotor shafts and the engaging surface of the second sub-housing, and
wherein the second oil outlet is arranged at a first distance from the engaging surface of the second sub-housing, the first distance greater than a second distance between the engaging surface of the second sub-housing and the second oil path.

28. An energy recovery device comprising:
a main housing having inlet and outlet ports, the inlet port configured to admit a working fluid, and the outlet port configured to discharge the working fluid;
a plurality of rotors rotatably disposed in the main housing;
a plurality of rotor shafts associated with the plurality of rotors, each of the plurality of rotor shafts having a first end and a second end along an axis of rotation, and at least one of the plurality of rotor shafts including a hollow at least partially extending between the first and second ends along the axis of rotation;
a first sub-housing attached to the main housing and including a first interior configured to at least partially receive the plurality of rotor shafts and rotatably support the plurality of rotor shafts at the first end;
a second sub-housing attached to the main housing and including a second interior configured to at least partially receive the plurality of rotor shafts and rotatably support the plurality of rotor shafts at the second end;
an oil outlet being in fluid communication with the first interior of the first sub-housing and configured to discharge the oil therefrom; and
an oil inlet being in fluid communication with the second interior of the second sub-housing and configured to receive the oil therein,
wherein the hollow is configured to be in fluid communication with the first interior of the first sub-housing at the first end and in fluid communication with the second interior of the second sub-housing at the second end to enable an oil to flow between the first and second interiors.

29. The energy recovery device according to claim 28, further comprising:
a plurality of rotatory components rotatably disposed in the first sub-housing and operatively coupled to the plurality of rotor shafts at the first end.

30. The energy recovery device according to claim 29, wherein the plurality of rotary components includes a plurality of meshed timing gears.

31. The energy recovery device according to claim 29 or 30, wherein the plurality of rotary components is exposed to the first interior of the first sub-housing and operates as a pump to agitate the lubricant within the first sub-housing.

32. The energy recovery device according to any of claim 28-31, further comprising at least one plain bearing configured to rotatably support at least one of the rotor shafts at the second end thereof within the second sub-housing.

33. An energy recovery device comprising:
a housing including an oil inlet and an oil outlet and having inlet and outlet ports, the inlet port configured to admit a working fluid, and the outlet port configured to discharge the working fluid;
a plurality of rotors rotatably disposed in the housing; and
a plurality of rotor shafts associated with the plurality of rotors, each of the plurality of rotor shafts having a first end and a second end along an axis of rotation, and at least one of the plurality of rotor shafts including a hollow at least partially extending between the first and second ends along the axis of rotation to enable an oil to flow therethrough between the first and second ends;
wherein the oil inlet is configured to receive the oil and in fluid communication with the hollow of the rotor shaft at the first end to enable the oil to flow from the oil inlet to the hollow of the rotor shaft at the first end, and
wherein the oil outlet is configured to discharge the oil therefrom and in fluid communication with the hollow of the rotor shaft at the second end to discharge the oil from the hollow of the rotor shaft to the oil outlet at the second end.
